(19) United States
(12) Patent Application Publication
(10) Pub. No.: US 2026/0061876 A1
(43) Pub. Date: Mar. 5, 2026

(54) MULTI-OBJECTIVE OPTIMIZATION OF DISTRIBUTED ENERGY RESOURCES USING MULTI-STAGE OPTIMIZATION

(71) Applicant: PowerFlex Systems, LLC, San Diego, CA (US)

(72) Inventors: Zachary Jordan LEE, Pasadena, CA (US); Robin GUARNOTTA, Paris (FR); Mohammad GHALJEHEI, Tempe, AZ (US)

(21) Appl. No.: 19/311,532

(22) Filed: Aug. 27, 2025

Related U.S. Application Data
(60) Provisional application No. 63/687,727, filed on Aug. 27, 2024.

(51) Int. Cl. B60L 53/62; B60L 53/302; B60L 53/31; B60L 53/51; B60L 53/53; B60L 53/54; B60L 53/64; B60L 53/68

(52) U.S. Cl. CPC B60L 53/62; B60L 53/302; B60L 53/31; B60L 53/51; B60L 53/53; B60L 53/54; B60L 53/64; B60L 53/68

(57) ABSTRACT

Certain aspects of the present disclosure provide techniques for controlling a plurality of energy assets. In examples, the techniques may include receiving an input indicative of selection of a first optimization strategy and a second optimization strategy of a plurality of optimization strategies related to controlling a plurality of energy assets; determining a plurality of values for a plurality of operational parameters for the plurality of energy assets based on the first optimization strategy and the second optimization strategy, wherein determining the plurality of values for the plurality of operational parameters for the plurality of energy assets comprises determining a first value for a first operational parameter for a first energy asset based on the first optimization strategy and the second optimization strategy; and controlling the plurality of energy assets based on the plurality of operational parameters.

### CROSS-REFERENCE TO RELATED APPLICATIONS

This application claims the benefit of and priority to U.S. Provisional Patent Application No. 63/687,727, filed on Aug. 27, 2024, the entire contents of which are hereby incorporated by reference.

### INTRODUCTION

Electric vehicle (EV) charging infrastructure is a rapidly growing field. An increasing number of EV charging stations and other energy resources are being deployed at various sites, and the EV charging networks at these sites continue to expand and become more diverse. As such, it is becoming increasingly complex to optimize the charging of EVs and/or the management of energy flow across many EV charging stations and energy resources, for example, for various optimization objectives.

One conventional way to optimize the charging of EVs and/or the management of energy flow at these EV charging networks may be to use scheduling algorithms or heuristics. For example, in the case of prioritization, this may mean that the scheduling algorithms iterate over a list of EV charging stations sorted by priority and allocate power until no additional power can be allocated. However, this approach is not very flexible, as the entire algorithm must be re-engineered each time a new priority scheme is to be applied. For example, these solutions are manually designed, and may only be suitable for project-based deployments.

Control of energy resources, such as EV charging stations, energy storage devices, renewable energy assets, etc. (e.g., distributed energy resources, including energy resources that may be installed near the point of use, such as, for example, at a given EV charging site, behind a meter), often involves tradeoffs among multiple objectives. In some cases, there may be a continuous tradeoff among the multiple objectives. For example, one of these objectives may be to prioritize charging via one particular EV charging station (e.g., over another EV charging station), while another one of the objectives may be to minimize charging cost for all EV charging stations, at a given site. In some cases, there may be a strict hierarchy of objectives which cannot be easily defined or achieved using the conventional methods. For example, a conventional method of mathematically modeling a hierarchy of objectives may be to assign weights for corresponding objectives. These weights may need to be sufficiently different relative to one another to ensure the hierarchy is maintained. In some cases, these weights may need to increase or decrease exponentially. Accordingly, performing optimization based on a hierarchy of objectives requires a high level of numerical precision in tracking the weights. Tracking the weights at a high level of numerical precision requires a lot of processing time and memory use. For example, tracking the exponentially increasing or decreasing weights may result in optimization failures due to not having enough memory for processing all the weights and/or timing out, etc.

As such, the conventional methods of optimizing the EV charging faces several technically challenging issues. Some examples of these technically challenging issues include: (1) it may be difficult to tune weights related to multiple objectives (e.g., to assign numerical values to the relative importance of goals without common units, such as, for example, minimizing the cost of energy to charge an EV and prioritizing the charging of certain EVs over others) in a single optimization, to achieve the desired hierarchy of objectives; (2) optimizing the EV charging for multiple objectives mathematically or programmatically often results in numerical issues in optimization solver (e.g., a computerized system or software configured for solving the optimization programmatically), where the solver may take too long to converge to a solution, fail to converge at all, or converge to a suboptimal solution; (3) in some cases, it may be very difficult, if not impossible, to phrase a desired objective as a single optimization; (4) it may be difficult to understand why a multi-objective optimization arrived at the solution it did, given the tradeoffs it must make; and (5) it may be difficult to describe a multi-objective optimization in a simple-to-configure-yet-flexible framework. As the EV charging infrastructure continues to expand, these problems are expected to become more pronounced.

### SUMMARY

In accordance with certain embodiments of the present disclosure, a method is provided for controlling a plurality of energy assets. The method may include: receiving an input indicative of selection of a first optimization strategy and a second optimization strategy of a plurality of optimization strategies related to controlling a plurality of energy assets; determining a plurality of values for a plurality of operational parameters for the plurality of energy assets based on the first optimization strategy and the second optimization strategy, wherein determining the plurality of values for the plurality of operational parameters for the plurality of energy assets comprises determining a first value for a first operational parameter for a first energy asset based on the first optimization strategy and the second optimization strategy; and controlling the plurality of energy assets based on the plurality of operational parameters.

Other embodiments of the present disclosure may provide non-transitory, computer-readable mediums comprising instructions that, when executed by one or more processors of one or more processing systems, cause the one or more processing systems to perform the aforementioned methods as well as those further described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a computing environment for controlling a plurality of energy assets, according to embodiments provided herein;

FIG. 2 depicts a software configuration for an edge environment for controlling a plurality of energy assets, according to embodiments provided herein;

FIGS. 3A-3C depict device configurations for an edge environment for controlling a plurality of energy assets, according to embodiments provided herein;

FIGS. 4A-4C depict hardware that may be utilized for the devices from FIGS. 3A-3C, according to embodiments provided herein;

FIG. 5 depicts a software configuration for a cloud environment for controlling a plurality of energy assets, according to embodiments provided herein;

FIG. 6A depicts an example flow diagram illustrating a method for controlling a plurality of energy assets, according to embodiments provided herein;

FIG. 6B depicts an example flow diagram related to a portion of the method of FIG. 6A, according to embodiments provided herein;

FIG. 6C depicts an example flow diagram related to a portion of the method of FIG. 6A, according to embodiments provided herein;

FIG. 7 depicts an example graphical user interface for controlling a plurality of energy assets, according to embodiments provided herein;

FIG. 8 depicts an example flowchart illustrating a method for controlling a plurality of energy assets, according to embodiments provided herein; and

FIG. 9 depicts an example processing system configured to perform the methods described herein.

### DETAILED DESCRIPTION

Embodiments disclosed herein include systems and methods for controlling a plurality of assets (e.g., energy assets, also referred to herein as energy resources), such as a plurality of distributed energy resources of an electric vehicle (EV) charging network. An asset (e.g., an energy asset) may be, for example, an energy-generating equipment of the EV charging network or an energy-providing equipment of the EV charging network. Some examples of energy assets may include, but not be limited to: an EV charging station (e.g., an electric vehicle supply equipment (EVSE)), an energy storage device (e.g., a battery), a renewable energy source (e.g., a solar installation or a wind turbine), a heat battery, a generator, a fuel cell, a Heating, Ventilation, and Air Conditioning (HVAC) system, etc. The energy assets may be referred to as distributed energy resources, when the energy assets are installed near the point of use, such as, for example, at a given EV charging site, behind a meter. While at least some embodiments disclosed herein are described in the context of an EV charging network, certain embodiments may be applicable to other types of energy asset networks or sites without departing from the spirit and scope of the disclosure. Such energy asset networks or sites may include storage-only sites and other systems, having and/or for controlling one or more of: EV charging stations, battery energy storage systems, heat batteries, solar photovoltaic (PV) systems, generators, fuel cells, HVAC systems, lighting controls, or water heaters, etc.

Some embodiments optimize control systems and/or methods by solving multi-objective optimization problems in multiple stages. Certain embodiments provide the capability for designing a multi-stage, multi-objective optimization problem using equipment, network, strategy, and persistence models. For example, the multi-stage, multi-objective optimization problem may be an optimization problem, which may be represented by one or more objective functions, and solved programmatically. An objective function is a (e.g., mathematical) function of one or more variables, where the value of the function is to be minimized or maximized. One or more criteria (which may be referred to herein as constraints) related to the one or more variables provide the lower and/or the upper boundaries of an allowable set of values for the variables (e.g., those that satisfy the constraints), and may be related to one or more optimization objectives. For example, an objective function may be a function of one or more charging rates (e.g., variables) of one or more EV charging stations, and the value of the objective function may be a total cost of EV charging via the one or more EV charging stations, where the total cost is to be minimized. The constraint(s) related to this example may be given by, for example, one or more threshold values for the one or more charging rates, which result in the minimized total cost (e.g., the minimized value of the objective function). Such problem may be solved, for example, programmatically, to find the appropriate values for the variables (e.g., satisfying the one or more criteria/constraints), which minimize or maximize the value of the objective function.

Equipment models may represent physical equipment on a site, such as EV charging stations, energy storage systems, and other energy assets such as, for example, meters for solar generation and building load.

Network models may represent the way the modeled equipment is supplied power, including any constraints in electrical infrastructure such as, for example, breaker, wire, interconnection, and/or transformer limits.

Strategy models may represent how certain energy assets (e.g., distributed energy resources) may be controlled. Each strategy can be represented by zero or more constraints and/or zero or more functions to be added to the objective function of an optimization problem. For example, each strategy (e.g., corresponding to an optimization objective) can include zero or more criteria related to an allowable set of values for any variable(s) of any objective function(s). Adding the objective function(s) may refer to adding (e.g., mathematically) the new objective function(s) to the existing objective function(s). In addition or alternatively, adding or combining the objective function(s) may refer to utilizing one or more constraint(s) from the existing objective function(s) for the new objective function(s). For example, solving the new objective function(s) with the existing constraint(s) in consideration may result in additional constraint(s) that, for example, further narrow the allowable set of values that satisfy the minimized or maximized value of the new objective function(s). The added or combined objective functions may represent the multi-objective optimization problem.

Accordingly, when a multi-stage, multi-objective optimization problem is solved, the result is an allowable set of values for the variables, subject to the constraint(s) of the optimization problem. For example, the resulting allowable set of values for the variables (e.g., charging rates) may be used for controlling one or more energy assets of a given EV charging network. In certain embodiments, the objective functions and/or the constraints may be added in multiple stages, as described herein (e.g., a first objective function, related to a first constraint, being added in a first optimization stage; and a second objective function, related to a second constraint, being added in a second optimization stage, etc., in series).

Persistence models may represent how one stage of optimization may interact with other stage(s) of optimization. These may include constraint(s) to be remembered or applied for one or more subsequent stages of optimization based on the solution of a previous stage of optimization. Embodiments of systems and methods for controlling a plurality of energy assets, incorporating the same, will be described in more detail, below.

In certain cases where the operations of energy assets for multiple objectives and/or constraints are being optimized, balancing the objectives can often present technically challenging obstacles to designing objective functions to properly encode the tradeoffs of the optimization problem. For example, adding additional groups of charging stations (e.g., prioritized groups of charging stations) may result in each lower-priority group of charging stations requiring exponentially decreasing weight. For example, the cost of delaying charging from a first group of charging stations may need to be higher than the cost of never charging from a second group of charging stations, where the first group may be of a higher priority than the second group. Encoding this tradeoff mathematically may result in the exponentially decreasing weight for each lower-priority group of charging stations. In another example, minimizing cost while also equally sharing charging power as much as possible may introduce a similarly challenging complexity in, for example, assigning numerical values to the relative importance of these goals without common units. For example, the objective of equally sharing charging power may involve solving a non-linear (e.g., quadratic) function.

Certain embodiments of the present disclosure address these technically challenging obstacles by introducing modular stages which can be combined to solve complex multi-objective optimization problems without the need to, for example, tune weights corresponding to the multiple objectives. For example, in a first optimization stage, an objective may be to minimize the cost of delaying charging from a first group of charging stations. The first stage may require a certain constraint on, for example, solving an optimization problem related to minimizing the cost of delaying charging from the first group of charging stations. For example, solving this optimization problem may provide a certain constraint on one or more variables of the optimization problem, where the one or more variables may include, for example, a charging rate associated with a given charging station of the first group, etc. Then, minimizing the cost of delaying charging from a second group of charging stations may be defined by a second optimization problem, where the first constraint (e.g., from solving the first optimization problem) may still apply. By allowing the first constraint to be applied (e.g., rather than defining a tradeoff between charging from a first group of charging stations and charging from a second group of charging stations by weights), the techniques described herein may avoid the numerical precision issues that can arise from trying to define such tradeoff(s), especially, with an increasing number of optimization objectives, etc.

The resulting algorithm may be flexible in the problems it can model, and more numerically stable, because the multiple objectives are achieved in a modular and ordered manner, with the objective function(s) of each stage being solved for the constraint(s) for each stage, which is/are then considered for subsequent stage(s) of optimization (e.g., in series). For example, the resulting algorithm of certain embodiments of the present disclosure mitigate the need to design a single complex objective function, with weights for multiple objective functions to be tuned in a complex manner. Accordingly, certain embodiments of the present disclosure increase the flexibility and/or scalability of the optimization algorithm. This “building blocks” approach may enable each stage of optimization to be robustly defined, including how each stage may interact with subsequent stage(s).

In some embodiments, the systems and/or methods described herein may enable increased flexibility and scalability because the need to tune weights for multiple objectives when designing an optimization problem for a particular use case is mitigated. For example, the significant engineering effort (e.g., requiring additional system and/or method complexity) to ensure that weights are properly set to balance both the desired behavior and numerical stability for multiple objectives, required for each new use case, may be mitigated by the systems and/or methods described herein. For example, certain embodiments of the present disclosure reduce system delays and/or sub-optimal control of assets (e.g., thereby lowering wasted energy). In certain embodiments, also reduced may be numerical issues and/or timeouts associated with, for example, weight-tuning for solving multi-objective optimization problems. The reduced numerical issues and/or timeouts may enable more robust solutions with complex optimization models (e.g., when compared to conventional systems or methods of optimization).

Certain embodiments of the present disclosure enable a more flexible approach (e.g., when compared to conventional systems or methods of optimization) to solving multi-objective optimization problems by enabling problems, which are otherwise difficult or impossible to be described with single-stage optimizations, to be properly defined. Moreover, some embodiments of the present disclosure enable re-use of “building blocks” when designing (e.g., defining) a given optimization problem, which is a significant technical improvement over having dedicated algorithms for different use cases, each of which may require a (e.g., incrementally) new design or definition of optimization.

### Example Computing Environment

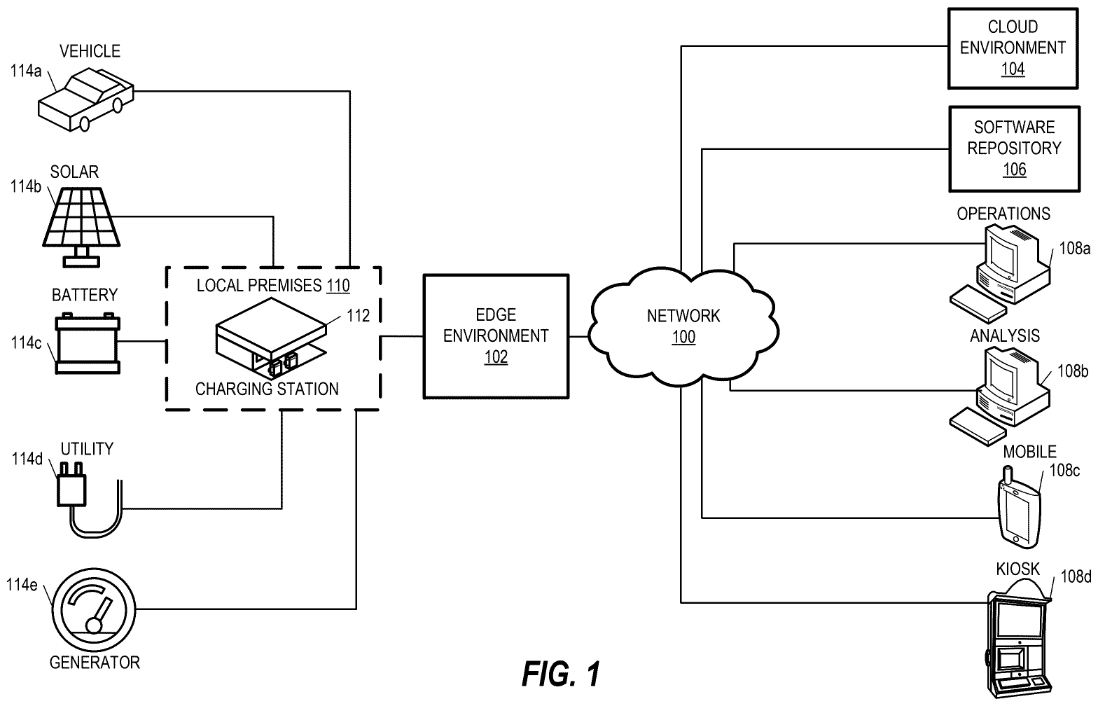

Referring now to the drawings, FIG. 1 depicts a computing environment for controlling a plurality of energy assets, according to embodiments provided herein. As illustrated, the computing environment includes a network 100 that is coupled to an edge environment 102, a cloud environment 104, a software repository 106, as well as one or more ancillary devices 108 (including an operations device 108a, an analysis device 108b, a mobile device 108c, and/or a kiosk device 108d). The network 100 may be configured as any wide area network (WAN, such as the internet, power network, cellular network, etc.) or other network for facilitating communication among the edge environment 102, the cloud environment 104, the software repository 106, and the ancillary devices 108.

Edge environment 102 may generally be deployed at a local premises site 110 (also referred to herein as a site) to provide various services, including coordination and optimization of one or more energy assets 114 (including an EV 114a, a solar device 114b, a battery energy storage system (BESS) 114c, a utility grid 114d, and/or a generator 114e), such as charging of electric vehicles (e.g., EV 114a) using charging station 112 and controlling one or more of various distributed energy resources (DERs), such as solar device 114b, BESS 114c, utility grid 114d, and/or generator 114e (e.g., an on-site diesel, natural gas, or other type of fueled generator). Generally, the aforementioned DERs may provide energy to the charging station 112 and/or use energy from the charging station 112 (e.g., by way of a backflow of energy from EV 114a to other aspects of site 110). In some embodiments, charging station 112 may send excess energy back to the BESS 114c and/or to utility grid 114d. Generally, edge environment 102 may monitor and/or modify the energy sent to and received from the DERs to optimize various tasks, such as charging of EV 114a.

Charging station 112 may utilize one or more of various communication protocols, such as open smart charging protocol (OSCP), open charge point interface (OCPI), ISO 15118, OpenADR, open charge point protocol (OCPP), etc. and may represent Level 1, Level 2, Level 3 (e.g., DC Fast Charging), and higher level charging stations, as applicable. Generally, the “level” of a charging station refers to the power level and/or ability to provide electric power to a device being charged.

Edge environment 102 is configured as an interface between various aspects of site 110 and network 100. In various embodiments, compute resources for performing different functions at a site, such as control or optimization of EV charging, may be split between local compute resources in edge environment 102 and remote compute resources, for example, in cloud environment 104 of FIG. 1.

Cloud environment 104 is coupled to the edge environment 102 via the network 100 and may be configured for further processing of data, as described herein. While FIG. 1 depicts a single cloud environment 104 that serves a single edge environment 102, this is merely an example, as some embodiments may be configured such that the cloud environment 104 may serve a plurality of edge environments 102 that each serve one or more sites 110, one or more charging stations 112, one or more DERs, and the like.

Software repository 106 is also coupled to site 110 via network 100. Software repository 106 may be configured as a platform to program, store, manage, and/or control changes, etc. to software that is implemented in edge environment 102 and/or cloud environment 104. In some embodiments, software repository 106 may be configured as a proprietary service and/or may be provided by a third-party, such as GitHub™. Additionally, some embodiments may be configured such that the software repository 106 is provided by the same entity that manages the cloud environment 104. As such, these embodiments may be configured such that software repository 106 and cloud environment 104 may be combined.

With respect to the ancillary devices 108, the operations device 108a may be utilized to monitor and/or alter operations of the computing environment provided in FIG. 1. The analysis device 108b may analyze utilization, operation, charging, and/or other features of the computing environment provided in FIG. 1. The mobile device 108c may represent an administrator device and/or a user device. As a user device, the mobile device 108c may initiate charging, perform payment, and/or perform other user-specific actions. As an administrator device, the mobile device 108c may perform administrative operations, analysis, and/or other actions. The kiosk device 108d may be located at one of the charging stations 112 and/or remote therefrom and may provide user-specific or administrative actions, similar to that of the mobile device 108c. In some embodiments, one or more administrators may use the kiosk device 108d to view information about a site or make changes. As will be understood by one of ordinary skill in the art, the ancillary devices 108 may each include one or more processors, one or more memory components, and/or other hardware and/or software for performing the functionalities provided herein. It should be understood that while the kiosk device 108d is depicted as being remote from the site 110, some embodiments may not be configured in this manner. Specifically, some embodiments may utilize a kiosk device 108d that is local at the site 110, which may communicate via a local network and/or the network 100 for providing the services described herein.

### Example Edge Environment

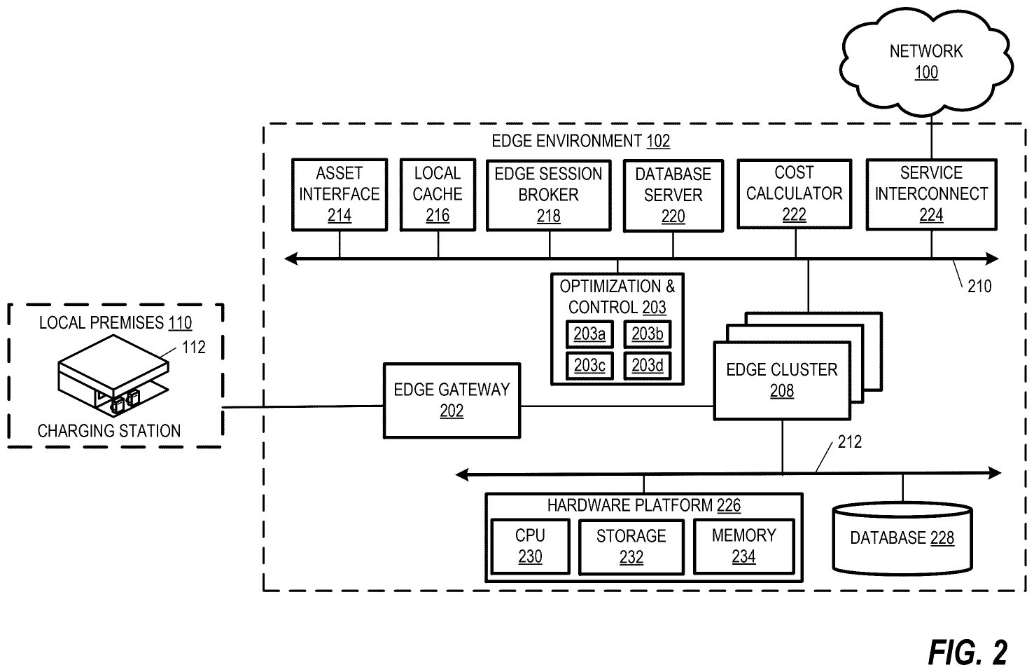

Referring now to FIG. 2, the edge environment 102 may be coupled to the site 110 via an edge gateway 202. Edge environment 102 may be operatively coupled to various aspects of site 110, such as charging station 112 via edge gateway 202. Edge environment 102 further includes an edge cluster 208, which is coupled to communication bus 210 and hardware bus 212. Communication bus 210 is coupled to optimization and control manager 203, asset interface 214, local cache 216, edge session broker 218, database server 220, cost calculator 222, and service interconnect 224 in this example. Hardware bus 212 is coupled to hardware platform 226, which may include one or more processors, such as CPU 230, one or more storage components 232, one or more memory components 234, and/or other hardware components. Also coupled to hardware bus 212 is database 228. Though certain components (e.g., cost calculator 222, database server 220, etc.) of edge environment 102 are depicted separate from hardware platform 226, they may be services or processes configured to run on hardware platform 226. Further, though certain components are illustrated as separate components, the functionality of such components may be combined into a single component and/or further divided among additional components.

Communication bus 210 and hardware bus 212 may be utilized to facilitate operation of all services that run in edge environment 102 and communicate with each other via a distributed message streaming system. The coupling of the aforementioned services may be accomplished in some embodiments via a distributed message streaming system, such as NATS.

In the depicted example, charging station 112 is configured for communication with edge environment 102 via edge gateway 202, such as via a short-range wireless network technology, such as via a Zigbee® PAN. The edge gateway 202 may be configured to receive data, such as electric vehicle charging data, price change data, vehicle data, etc. from the charging station 112 and/or vehicles that are being charged via the connection with the site 110 (of FIG. 1).

In some embodiments, edge gateway 202 may be configured to abstract data received from various aspects of site 110 (of FIG. 1), such as charging station 112, to remove protocol-specific distinctions. For example, a first charging station may utilize a first communication protocol and/or billing protocol and a second charging station may utilize a second communication protocol and/or billing protocol. Edge gateway 202 may receive data packets from both the first charging station using the first communication protocol and the second charging station using the second communication protocol, and may transform the received data into a protocol-agnostic format prior to providing the data to edge cluster 208. This may enable wide interoperability between edge environment 102 and various types of hardware (e.g., charging station 112) at a site.

Edge cluster 208 is the central message center in various embodiments. For example, when a user plugs a vehicle into a charging station 112, edge cluster 208 receives data from edge gateway 202, parses that data (e.g., to generate access state data) and causes the state data to be sent to the database server 220. Edge cluster 208 also receives the data and creates a session entry, which may be stored in the local cache 216. Edge cluster 208 may additionally send the session entry to the cloud environment 104 (of FIG. 1) via network 100. Edge session broker 218 may also receive data related to the new session and may query database server 220 to access additional session data to determine charging characteristics for charging station 112.

The edge session broker 218 may produce data or signals that are sent to the edge cluster 208, which may be sent to the edge gateway 202 for potentially sending back to one or more of the charging stations 112. Information that may be reported might include current delivered over time (e.g., amperes), total energy delivered (e.g., kWh), power delivered over time (e.g., kW), voltage at the charging station over time (e.g., V), charging station state (e.g., connected, disconnected, offline), connectivity state, charging state, etc. The charging stations 112 may report any errors back to the edge cluster 208. The cost calculator 222 may be engaged to access pricing data from the cloud environment 104 and may calculate costs incurred based on delivered energy, expected costs prior to charging, idle time interval, parking time interval, etc. The asset interface 214 may be a software interface between the edge environment 102 and the energy assets 114.

Edge cluster 208 may be configured such that any message received by the edge cluster 208 may also be sent to the cloud environment 104 (of FIG. 1) for consumption by a data subscriber in the cloud environment 104. For example, if a user of the mobile device 108c (in FIG. 1) desires to claim a charging session, mobile device 108c does not need to access edge environment 102 directly. Instead, mobile device 108c may connect with the cloud environment 104 (of FIG. 1), which sends a message to the edge cluster 208 with an instruction to claim the session. Service interconnect 224 is configured for establishing an HTTP, TCP, and/or other type of communication with the cloud environment 104 (of FIG. 1) via network 100.

The optimization and control manager 203 may provide energy optimization and adaptive load management (ALM) functions, for example, for various energy assets 114 at the site 110 (of FIG. 1). For example, the optimization and control manager 203 may be responsible for calculating set-points for each asset for the energy optimization and ALM amongst the energy assets 114 and providing data related to the calculated set-points to the asset interface 214. A set-point may be a value for a parameter (or a set of values for a set of parameters), such as a charging rate. In certain embodiments, the optimization and control manager 203 may include a database layer 203a to store data related to site configurations; an orchestration layer 203b to gather data, trigger optimizations, and/or issue set-points (e.g., provide the calculated set-points to energy assets); an optimization layer 203c to formulate and solve optimization problems to calculate set-points; and/or a control layer 203d for higher frequency feedback based controls (e.g., for modifying set-points to respond to fast time-scale events).

Optimization and control manager 203 may determine when optimization set-points need to be updated. Examples of when optimization set-points need to be updated include, but are not limited to: (1) when a new energy asset is installed at a site, (2) when a new vehicle to be charged arrives at a site, (3) when a measured value such as load or generation changes, (4) when a system parameter such as the target energy for a vehicle is updated, (5) when an external event occurs (such as a demand response event), and/or (6) at a fixed cadence (e.g., every 5 minutes). When it is determined that the optimization set-points need to be updated, optimization and control manager 203 may collect data needed for optimization, including optimization configuration from the cloud environment 104 of FIG. 1 (which can also be cached at edge environment 102) and/or state information from edge environment 102 and/or cloud environment 104. Examples of the optimization configuration include, but are not limited to: network and equipment constraints, optimization parameters such as precision and timeout settings, and/or weighted strategies. In certain embodiments, the state information from edge environment 102 and/or cloud environment 104 includes the states of the energy assets, as well as other state information including EV driver preferences, price signals, and grid signals. Further, optimization and control manager 203 may perform optimization (e.g., by the methods described further herein) to calculate new set-points and/or updated set-points. In certain embodiments, optimization and control manager 203 may (e.g., optionally) run a fast time-scale control loop which adjusts set-points in real-time in response to fast changing signals, such as building load, solar generation, or grid signals. In some embodiments, the functionalities of the optimization and control manager 203 may be implemented, at least in part, within the cloud environment 104 (of FIG. 1).

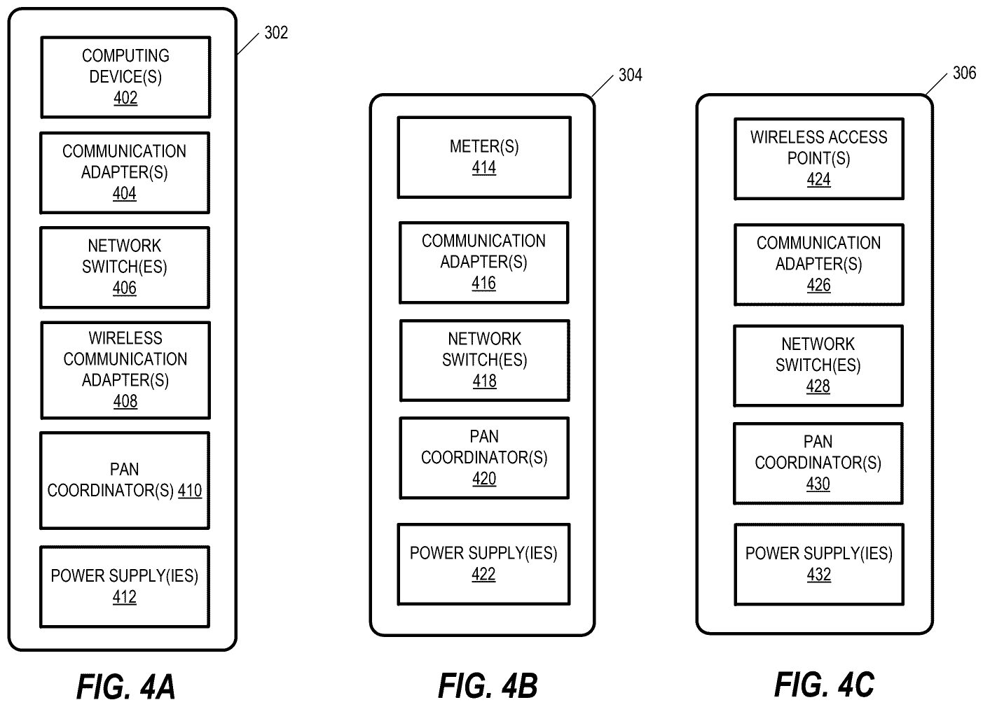

Hardware platform 226 represents any hardware for facilitating the processes and actions described herein. Specifically, one or more CPUs 230 may represent one or more types of processing device configured for executing instructions. One or more storage components 232 may be configured as long term storage, such as a hard drive or the like. One or more memory components 234 may include any of various types of random access memory or the like. One or more databases 228 may be configured for additional storage and may be housed with the other hardware and/or elsewhere. Examples of different hardware platforms that may be deployed in edge environment 102 are described further, below, with respect to FIGS. 4A-4C.

### Hardware Configurations for Edge Environment

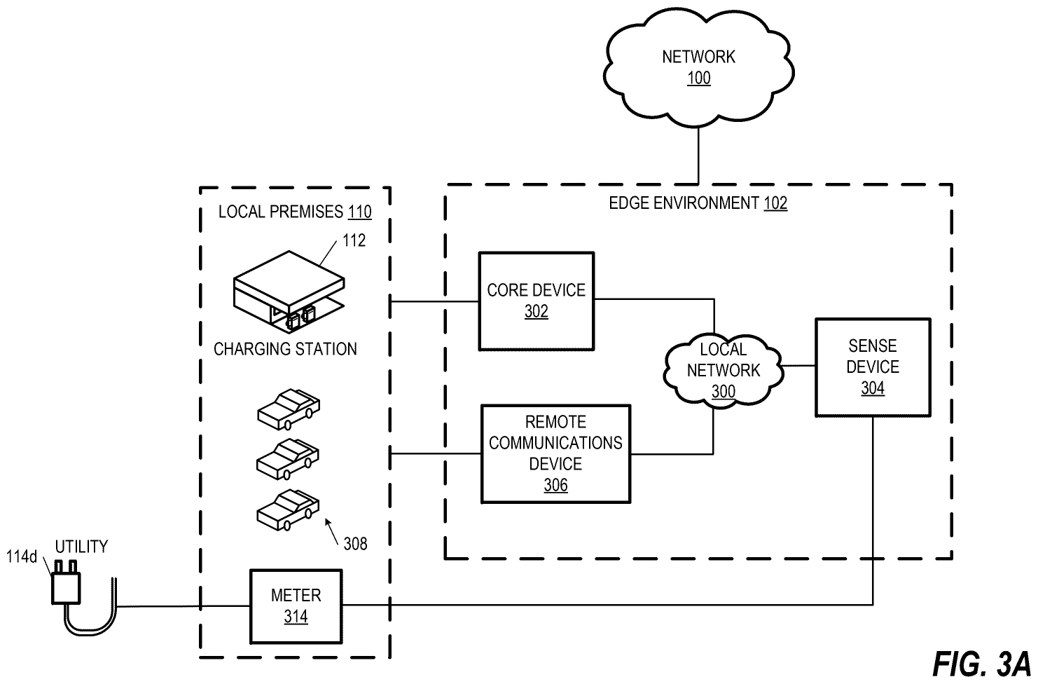

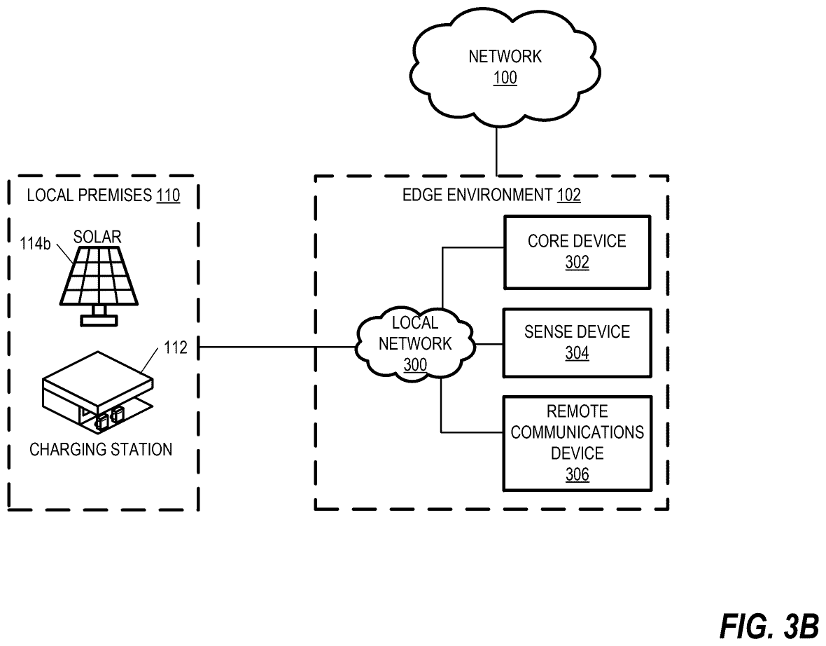

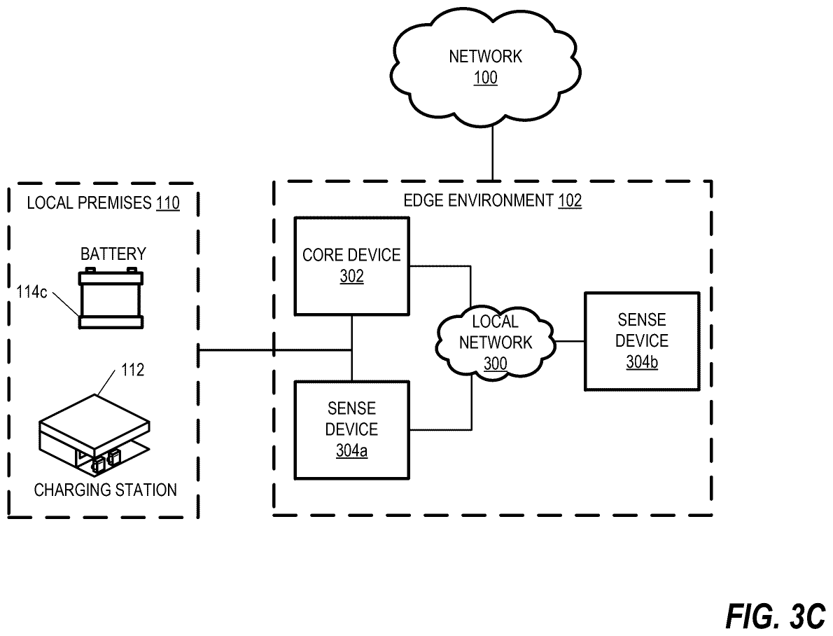

FIGS. 3A-3C depict example device configurations for edge environment 102, according to embodiments provided herein. Specifically, FIG. 3A depicts a charging solution. As illustrated, the charging station 112 is coupled to a local network 300 via a core device 302. The local network 300 may include any local area network, Ethernet, PAN, etc. The core device 302 may be physically installed within communications range of one or more chargers in the charging station 112. A sense device 304 may be installed, for example, in an electrical room or in another enclosure with electrical equipment of the charging station 112 and/or one or more energy assets 114, to monitor the main metering point for the local utility point of common coupling. This may enable one or more algorithms to provide the optimal dispatch of EV charging power, subject to local energy rates and the vehicles currently charging. In the case that there are vehicles 308 using EV chargers that are out of communications range of the core device 302, such as a sub-level of a parking garage, one or more remote communications devices 306 may be included. In certain embodiments, at least one of the one or more remote communications devices 306 may be in data communication with the charging station 112 (e.g., having one or more EV chargers charging one or more vehicles 308) and/or vehicles 308. Also included at the site 110 is a meter 314 for communicating energy with the utility grid 114d.

The core device 302 shown in FIG. 3A is the central processing device and serves as the communications hub. In certain embodiments, the components of FIG. 2 may generally operate, at least in part, as part of the core device 302. The core device 302 may provide optimization, load management, communication coordination, and/or data historian services. The core device 302 may communicate with the cloud environment 104 via cellular modem, wired internet service provider (ISP), and/or other communications medium to get current optimization and load management set-points for charging stations 112 and/or other assets, such as via an optimization algorithm that may be stored locally and/or at the cloud environment 104. It will be understood, however, that some embodiments may be configured such that the core device 302 performs optimization locally. In certain embodiments, the core device 302 dispatches these set-points, through a local communications protocol (e.g., Wi-Fi) and/or via the remote communications device 306 to reach locations that are distant or hard to reach, such as charging stations with a core device 302 and/or sense device 304 at sub-levels of a parking garage or a rooftop solar inverter. The core device 302 may additionally or alternatively collect data directly from distributed energy resources and power measurement devices or through cloud-based communications with the network 100.

Power and energy metering data may be collected via the sense device 304. The sense device 304 may include a smart meter with support for multiple single- and three-phase loads, such as with a local historian and Ethernet communication back to the device via the local network 300. The sense device 304 may also incorporate support for additional devices running on the edge including but not limited to thermocouple wiring, weather stations, temperature sensors, pyranometers, etc. It should be noted that additional sense devices 304 and remote communications devices 306 can be added to handle a variety of situations, such as a separate subpanel for energy metering of a new solar system or for monitoring of a new inverter associated with a rooftop solar installation.

FIG. 3B depicts a solar application where the core device 302 and the sense device 304 are installed in an electrical room or other common area. The sense device 304 can monitor the main metering point for the local utility as well as the solar production at tie-in breakers for the solar device 114b. The remote communications device 306 may be installed in a position to communicate directly with the solar device 114b and report the data received from the solar device 114b to the core device 302. Accordingly, the core device 302, the sense device 304, and the remote communications device 306 depicted in FIG. 3B may perform similar functions as those devices depicted in FIG. 3A.

FIG. 3C depicts a battery application where the core device 302 and the sense device 304 (including a first sense device 304a and a second sense device 304b) are installed physically near the BESS 114c. In some cases where the BESS 114c is near the point of common coupling with the utility grid 114d, a single sense device 304a can monitor the full site. In some cases where there is a significant distance to the metering point for the utility grid 114d, the second sense device 304b (or a plurality of second sense devices 304b) may be installed near the utility meter, such as the electrical room.

### Hardware Components in Core, Sense, and Remote Communications Devices

FIGS. 4A-4C depict hardware that may be utilized for the devices from FIGS. 3A-3C, according to embodiments provided herein. Specifically, FIG. 4A depicts hardware components that may be present in core device 302. In some embodiments, the core device 302 is the “brain” where the energy optimization and adaptive load management (ALM) functions (e.g., by the optimization and control manager 203 of FIG. 2) are executed and dispatched. As illustrated, the core device 302 may include one or more computing devices 402, one or more communication adapters 404, one or more network switches 406, one or more wireless communication adapters 408, one or more PAN coordinators 410, and/or one or more power supplies 412. As will be understood, the computing device(s) 402 may include one or more processors, one or more memories, and/or other components that a conventional, specific-purpose machine may utilize. In some embodiments, the computing device(s) 402 may include power line communication (PLC) infrastructure, while some embodiments may utilize retail and/or micro-industrial computer components for optimization, load management, communication coordination, and/or historian services.

The communication adapter(s) 404 may be configured for load balancing and otherwise managing communications of, for example, Modbus RTU (RS485) to Modbus TCP (Ethernet) or Ethernet IP (RJ45) to Ethernet Optical (SFP), etc. The network switch(es) 406 may be configured for routing of network traffic, and may be configured as an Ethernet switch for communication to other nodes (e.g., the sense device 304, the remote communications device 306, and/or other core device 302), distributed energy resources, and/or energy based management systems.

The wireless communication adapter(s) 408 may include a cellular modem, internet modem, Wi-Fi access point, etc. for facilitating wireless communications to the internet or other wide area network. Similarly, the PAN coordinator(s) 410 may be configured to create and/or join communication connections with other devices. This may include a Zigbee coordinator, Bluetooth device, and/or other device for performing this function. The power supply(ies) 412 may be configured as battery power, connection to external power, etc.

FIG. 4B depicts hardware components of the sense device 304 from FIGS. 3A-3C. The sense device 304 may be configured as a smart-metering piece for collection and storage of power/energy data such as measurements such as temperature, voltage, current, power, solar irradiance, wind speed, etc. The sense device 304 may include a smart meter with multiple channels of measurement that may comprise single-phase circuits and/or three-phase circuits. The sense device 304 may communicate meter data back to the core device 302 from meter locations such as electrical rooms, rooftop solar installations, EV chargers, and subpanels. Certain embodiments may be optimized for case of installation and reduced intrusion to the site. Power over Ethernet (POE) sourced from the core device 302 may suffice for most installations. The sense device 304 may transmit data back to the core device 302 via a network switch. The sense device 304 may be optimized to utilize minimal power, and PoE may be acceptable for most installations.

As illustrated in FIG. 4B, the sense device 304 includes one or more meters 414, one or more communication adapters 416, one or more network switches 418, one or more PAN coordinators 420, and/or one or more power supplies 422. The power supply(ies) 422 may include a power interface for providing power to the sense device 304. In certain embodiments, the meter(s) 414 may be power meter(s) utilized for monitoring single-phase and three-phase loads of power. The communication adapter(s) 416 may be utilized for facilitating communications between the sense device 304 and other devices. The network switch(es) 418 may be a PoE enabled switch for communication. Similarly, the PAN coordinator(s) 420 may create and/or join personal area networks, such as via Zigbee, Bluetooth, and the like. In some embodiments, PoE or other power source may be utilized.

As illustrated in FIG. 4C, the remote communications device 306 may be a network-connectivity extension, for example, for EV charging or solar monitoring locations where Zigbee, Wi-Fi, or Ethernet is being extended to remote or difficult-to-reach locations such as remote subpanels, parking garage levels, or rooftop inverters. Some embodiments are optimized for ease of installation and reduced intrusion to the site where PoE may suffice for most installations from the core device 302. The remote communications device 306 may be configured to transmit data back to the core device 302 via a network switch.

Specifically, the remote communications device 306 may include one or more wireless access points 424, one or more communication adapters 426, one or more network switches 428, one or more PAN coordinators 430, and/or one or more power supplies 432. The wireless access point(s) 424 may be configured to extend wireless communication signals to chargers and/or other intelligent electronic devices. The communication adapter(s) 426 may be configured for facilitating communications between the remote communications device 306 and other devices. The network switch(es) 428 may be configured as a PoE Ethernet switch and/or other network switch for communicating with the core device 302. The PAN coordinator(s) 430 may be configured to create and/or join personal area networks, such as via Zigbee, Bluetooth, and the like. The power supply(ies) 432 may include a power interface for providing power to the remote communications device 306.

### Example Cloud Environment

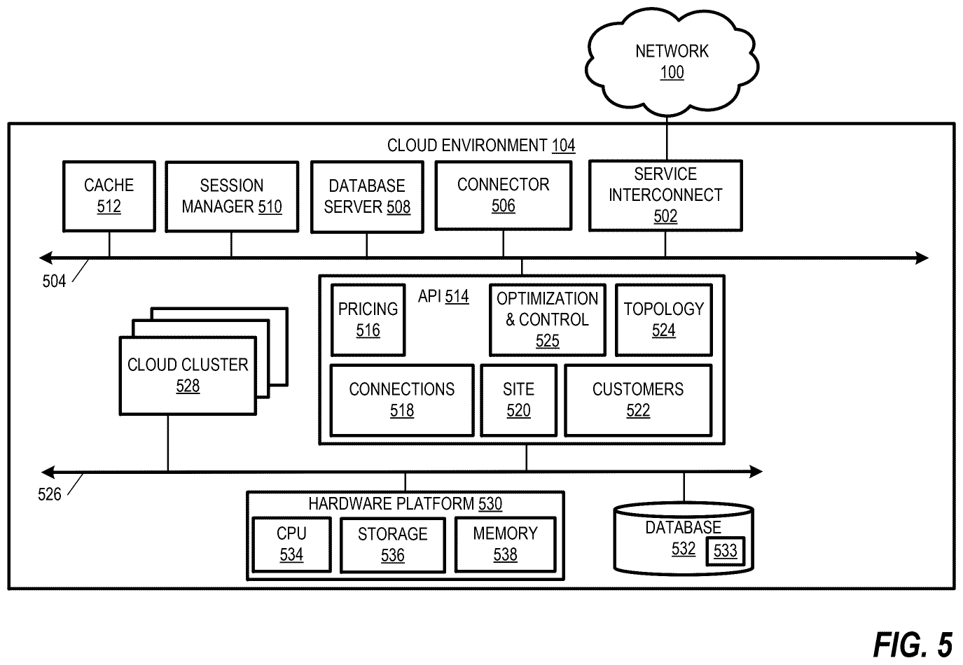

FIG. 5 depicts a device configuration for a cloud environment for controlling a plurality of energy assets, according to embodiments provided herein. As illustrated, the network 100 may couple to the cloud environment 104 via a service interconnect 502 that corresponds with the service interconnect 224 from FIG. 2. Similar to the service interconnect 224 from FIG. 2, the service interconnect 502 may be configured to facilitate an HTTP, TCP, and/or other communication portal through the network 100 to the edge environment 102 for the exchange of data between the edge environment 102 and the cloud environment 104. Additionally or alternatively, the service interconnect 502 may be configured to facilitate an HTTP, TCP, and/or other communication portal through the network 100 directly with an electric vehicle supply equipment (EVSE), such as charging station 112, for the exchange of data between the cloud environment 104 and the EVSE. For example, in some such embodiments, cloud environment 104 may be configured with the same or similar components as edge environment 102 (e.g., in addition or alternative to one or more components shown in FIG. 5) and configured to perform functions similar to edge environment 102, such that a separate edge environment 102 may not be needed.

The service interconnect 502 is coupled to a communication bus 504, which facilitates communication among various components of FIG. 5. Also connected to the communication bus 504 are a NATS connector 506, a database server 508, a session manager 510, a cache 512, and a collection of services and application programming interfaces (APIs) 514. The APIs 514 may include a pricing API 516, a connections API 518, a site API 520, a customers API 522, a topology API 524, and/or an optimization and control API 525. The APIs 514 may be implemented by hardware platform 530. Hardware bus 526 is coupled to a NATS cloud cluster 528, as well as the hardware platform 530 and a database 532. The hardware platform 530 may include one or more CPUs 534, one or more storage components 536, and one or more memory components 538. Though certain components of cloud environment 104 are depicted separate from hardware platform 530, they may be services or processes configured to run on hardware platform 530. Further, though certain components are illustrated as separate components, the functionality of such components may be combined into a single component and/or further divided among additional components.

The APIs 514 is a component of the cloud environment 104. As such, the APIs 514 (including the pricing API 516, the connections API 518, the site API 520, the customers API 522, the topology API 524, and/or the optimization and control API 525) may cause storage of and/or process site information, site topology, customers, connections to panels, constraints of panels, pricing information of each site, local forecasting services, optimization services, controller services, caching services, etc. The APIs 514 may also serve as a mobile backend by storing personal information of charge users (e.g., email, charging preferences, payment preferences, privileges, access, fleet information, etc.). The APIs 514 may additionally store peak charging configurations, data related to meter setup, etc. In some cases, the APIs 514 may also be responsible for tracking changes to EVSE connections and causing related changes to various types of data. For example, a newly connecting EVSE may create a new charging session, and a newly disconnecting EVSE may close a charging session. The connection and the disconnection may cause changes in payment information for user(s) of the connecting EVSE(s) or user(s) of the disconnecting EVSE(s), for example, related to payment for energy usage. In some embodiments, the pricing API 516 may be used for storing information related to pricing configuration of a charging site, such as the site 110 (of FIG. 1). Some examples of the information related to pricing configuration of a charging site may include, but not be limited to, cost for energy (e.g., $/kWh), cost for parking time (e.g., $/time-interval), cost for idle parking time (e.g., $/idle-time-interval), etc. In certain embodiments, the site API 520 may be or include a service that provides an API to read or change information about a charging site (e.g., site name, address, etc.). The topology API 524 may be used for storing information related to topology of EVSEs, and may be utilized to track, for example, which EVSEs are connected to which electrical panels and whether any electrical panels may be subpanels of other panels. Such information may be utilized for load management. In some embodiments, the optimization and control API 525 may be responsible for handling optimization requests, performing one or more optimization methods, and communicating the result of the optimization. For example, the optimization and control API 525 may be or include a service that may be executed when there is a newly connected or disconnected EVSE, such that an optimization may be performed to allocate (e.g., re-allocate) power according to updated state(s) of the EVSE(s). In some embodiments, optimization and control API 525 may enable per-site configuration of the optimization and control parameters. For example, these parameters can be updated via API(s) 514 (e.g., optimization and control API 525) directly or via a front-end interface. These parameters may include different parameters for each optimization strategy as well as the grouping of strategies (e.g., grouped into stages). Moreover, optimization and control API 525 may be used to store (e.g., via database 532) input and output pairs (e.g., related to various optimization scenarios, where an input may correspond to a combination of the optimization configuration and system state and an output may correspond to a collection of parameters for how the system should operate, etc.) for subsequent analysis.

When a vehicle is plugged into a charging station 112 (FIG. 1), the edge session broker 218 (FIG. 2) may communicate connection information to the APIs 514. The connection information may include vehicle information, user information, charging station information, etc. The APIs 514 then create a charge session object, which is stored in the cache 512. The cache 512 sends session data, along with topology constraints and the charge session object to the edge environment 102. The NATS connector 506 may additionally cause the NATS cloud cluster 528 to maintain the charge session object for retrieval by an interested party. As a session (e.g., a charge session) continues, the session manager 510 may be utilized to alter constraints of the session, which may cause the NATS cloud cluster 528 to update the charge session object.

When a user claims a previously created session with the mobile device 108c, the database server 508 may create a database entry (e.g., within the database 532) with the charge session, driver, energy request, willingness to pay, electricity purchased, etc. The NATS connector 506 may update the NATS cloud cluster 528 with the database entry. This data may then be sent to the edge environment 102. When the charge session ends (e.g., when the vehicle is unplugged), that action may be added to the database entry and the database entry may be moved from a current sessions list to a completed sessions list.

In certain embodiments, the database 532 may include optimization data 533 related to, for example, optimization scenarios (e.g., past optimization scenarios which may be used for debugging and/or auditing the performance of a given optimization scheme).

As indicated above, the hardware platform 530 may represent hardware that may be utilized to execute the components described regarding FIG. 5. As such, the CPU(s) 534 may be configured as any processing unit for receiving and executing computer-readable instructions. The storage component(s) 536 may be configured as any hard drive or other local storage device. The memory component(s) 538 may be configured as any type of RAM, ROM, registers, etc. or the like.

### Process for Multi-Stage, Multi-Objective Optimization

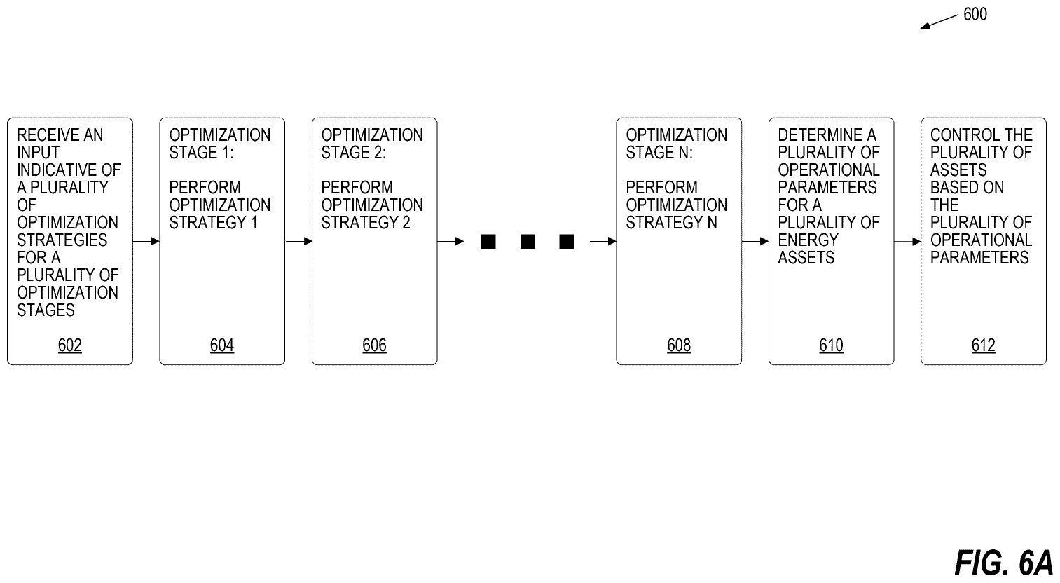

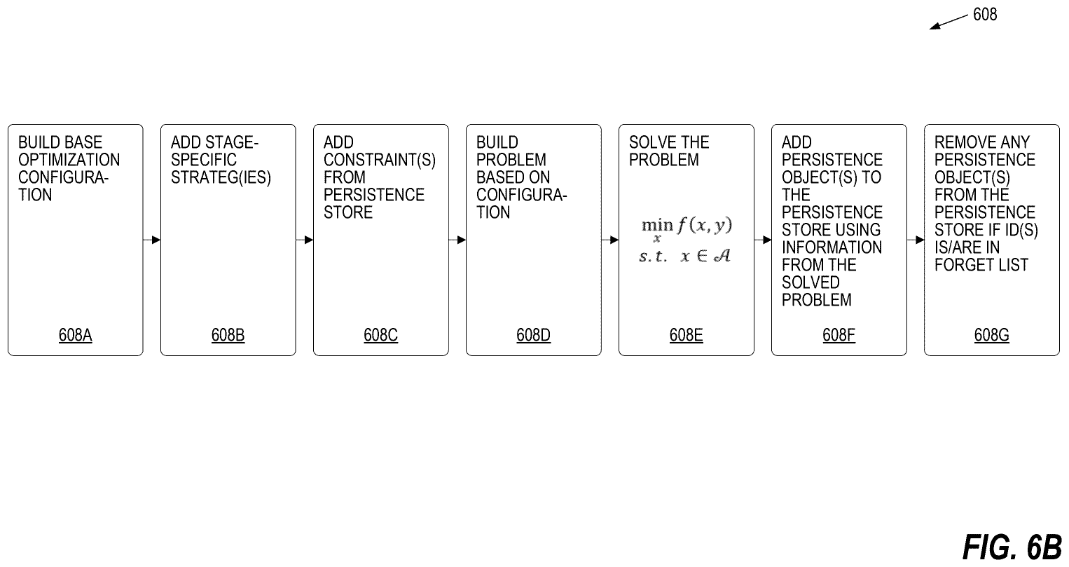

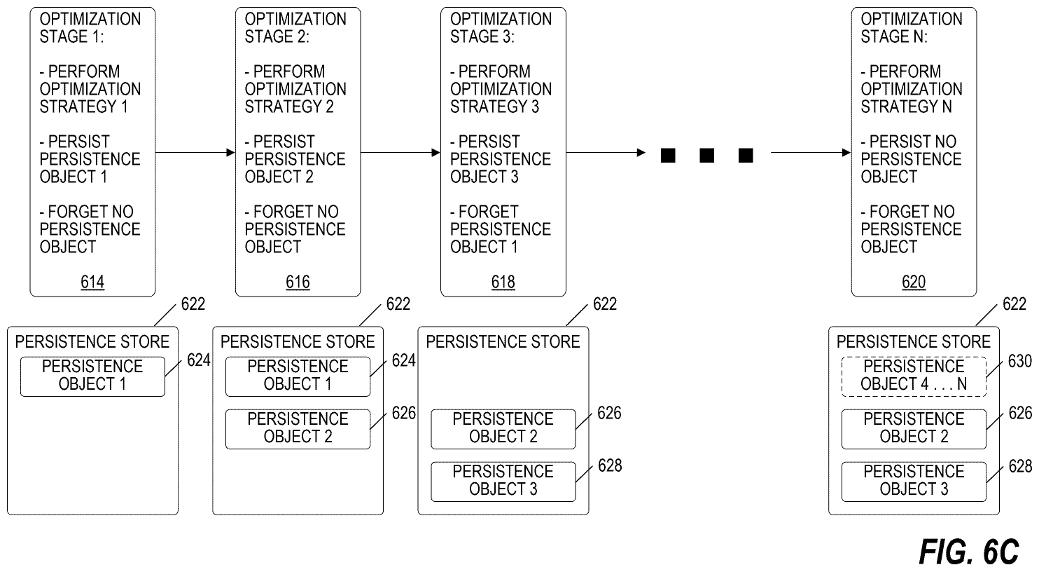

FIG. 6A depicts an example flow diagram for a multi-stage, multi-objective optimization process 600 of controlling a plurality of energy assets, according to embodiments provided herein. The process 600 may be performed by a core device 302 of FIG. 3, for example, by utilizing one or more components of edge environment 102 described herein with respect to FIG. 2 (e.g., the optimization and control manager 203 of FIG. 2) and/or one or more components of cloud environment 104 described herein with respect to FIG. 5 (e.g., the APIs 514 of FIG. 5, such as the optimization and control API 525).

In step 602, a control system or service (e.g., utilizing optimization and control manager 203 of FIG. 2), implemented on, for example, the core device 302 of FIG. 3, may receive an input indicative of a plurality of optimization strategies for a plurality of optimization stages, for controlling a plurality of energy assets. In certain embodiments, the plurality of optimization strategies may be a set of optimization strategies, each of which may have pre-determined definitions (e.g., including one or more objective function(s) and/or other programmed or (e.g., mathematical) definitions) related to a specific optimization strategy. For example, the pre-determined definitions may be defined and programmed for, for example, the optimization and control API 525 of FIG. 5. Some examples of the plurality of optimization strategies may correspond to, including but not limited to: charging with one or more charging stations as quickly as possible; charging with one or more charging stations, with a given remaining capacity, as quickly as possible; sharing power between two or more charging stations as equally as possible; prioritizing charging from a first charging station over charging from a second charging station; minimizing charging rate(s) for one or more charging stations; charging from all charging stations at a minimum charging rate; maximizing energy throughput; minimizing energy cost; etc. In certain embodiments, one or more charging stations may correspond to one or more groups of one or more charging stations (each having one or more chargers). Additionally, the plurality of optimization strategies may each include one or more operational parameters, such as related to one or more energy assets (e.g., charging stations). For example, one or more operational parameters may be one or more variables of one or more objective function(s) corresponding to each optimization strategy. In some embodiments, the input indicative of the plurality of optimization strategies for the plurality of optimization stages may be based on a user input received from, for example, an operator of the EV charging network, via a user interface.

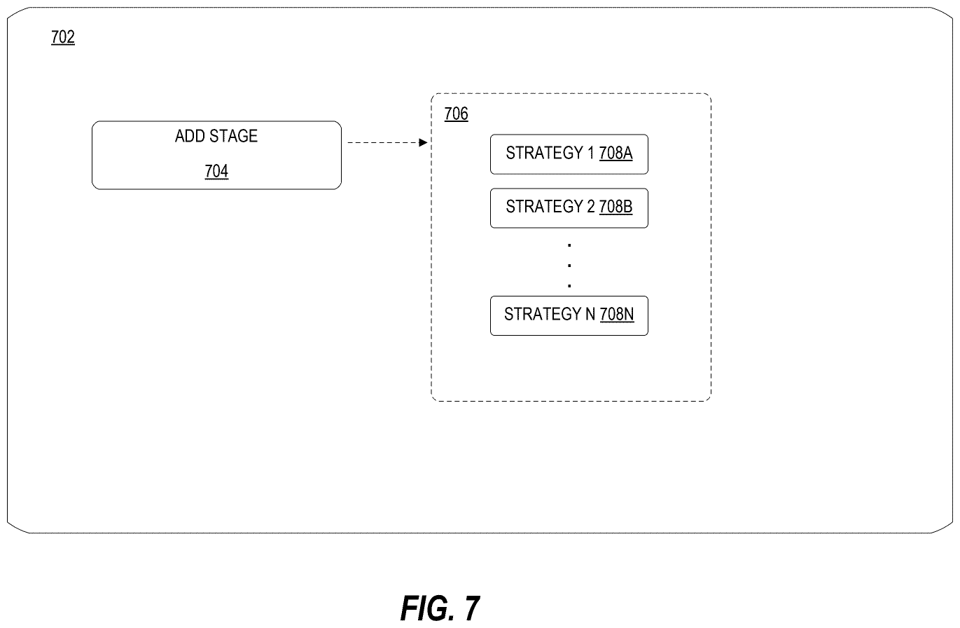

FIG. 7 depicts an example graphical user interface (e.g., user interface 702), for example, for receiving the input indicative of the plurality of optimization strategies for the plurality of optimization stages. The user interface 702 may be provided, for example, to an operator, via one or more of the ancillary devices 108 of FIG. 1. The user interface 702 may provide one or more first user interface elements 704 configured for adding a stage of optimization. Selection of a first user interface element 704 may populate, on the user interface 702, second user interface element 706 including a plurality of third user interface elements 708A-708N, each configured for selecting and adding a corresponding optimization strategy to the stage being added. Each subsequent selection of the first user interface element 704 may add a subsequent stage of optimization including a selected optimization strategy. Once all the desired optimization stages of optimization strategies have been added, an optimization problem corresponding to a hierarchical multi-stage optimization problem may be generated and solved (e.g., programmatically), based on the added optimization stages of optimization strategies.

Referring back to FIG. 6A, an example scenario for process 600 may be as follows. A site has three groups of chargers. The first group includes DC Fast Charging (DCFC) chargers designated for opportunity charging, where opportunity charging refers to the practice of charging a battery (e.g., an industrial battery) for short periods of time throughout the day. The second group is used for fleet charging (process of charging multiple vehicles, such as EVs, simultaneously). The third group includes the remaining chargers. Chargers in each group are to equally share charging capacity while maximizing throughput. An example hierarchy of objectives may be as follows: (1) all charging stations should deliver a minimum power to vehicles; (2) DCFC chargers in the first group should have the highest priority (e.g., the DCFC chargers should charge as close to their maximum charging rates as possible, given network and equipment constraints on the charging rates); (3) while minimizing total charging delays for the DCFC chargers, charging rates are to be allocated equally as much as possible; (4) fleet chargers in the second group should have the next highest priority; and (5) while minimizing total charging delays for the fleet chargers, charging rates are to be allocated equally as much as possible. Each of the five objectives may correspond an optimization strategy which may be selected (e.g., via user interface 702 of FIG. 7) for an optimization stage, where each optimization strategy may have a pre-determined definition (e.g., including one or more objective function(s) and/or other programmed or mathematical definition). A variable (e.g., an operational parameter) for each optimization strategy may be, for example, charging rate(s). In this example scenario, a user input indicative of a plurality of optimization strategies corresponding to the five optimization objectives described above, selected for five optimization stages, may be received by user interface 702 (e.g., of an optimization solving system) as part of step 602. This example scenario is referred back to for the description of FIGS. 6A-6C.

In order to perform the optimization of this example scenario without using the methods described herein, to prioritize charging for the first group (of DCFC chargers) over charging for the second group (of fleet chargers), charging for each charger in the first group at time t may be multiplied by the function (T−t−1), resulting in sum; sum, (T−t−1)rᵢ(t), where T is the number of intervals in an optimization horizon, t is an index of interval, and rᵢ(t) is a charging rate of vehicle i at interval t. This function is non-positive and monotonically increasing, so it is minimized when the first group charges as quickly as possible. To make the second group lower priority than the first group, a similar function may be used, but it may be multiplied by a weight. To ensure that the first group is higher priority, the second function may be set such that delaying charging from time t to t+1 for a charger in the first group results in a higher cost than never charging from a charger in the second group. For example, (T−t−1)−(T−t+1−1)>w_{2nd_group} (T−1), which may be solved to provide that w_{2nd_group}<1/(T−1). Using the same logic for a weight for the third group (of remaining chargers), of lower priority than the second group, may provide: w_{2nd_group} [(T−t−1)−(T−1+1−1)]>w_{3rd_group} (T−1), which results in w_{3rd_group}<1/(T−1)^{\hat{ }2}. This pattern would continue for each lower priority group which may be added, resulting in an exponentially decreasing weight for each lower priority group. Thus, as the number of lower priorities of groups being added grows, the exponentially decreasing weights resulting from an attempt to solve the optimization problem above (without using the methods described herein with respect to certain embodiments) may cause an issue in solving the optimization problem (e.g., related to numerical precision required for calculating and/or tracking the relevant weights). In contrast, the methods described herein mitigates the need to calculate and track such weights and provides a solution to the technical problem, such as related to the numerical precision issue, present in the foregoing manner of calculating and/or tracking weights.

Referring back to FIG. 6A, in step 604, the first optimization strategy corresponding to the first optimization stage may be implemented. For example, the first optimization problem corresponding to the first optimization strategy may be solved. Solving the first optimization problem may result in one or more values (e.g., an allowable set of values) for, for example, charging rate(s) (e.g., constraint(s), such as threshold(s), on the allowable set of values), which satisfy(ies) the objective of the first optimization strategy.

In step 606, the second optimization strategy corresponding to the second optimization stage may be implemented. For example, the second optimization problem corresponding to the second optimization strategy may be solved. Solving the second optimization problem may result in additional constraint(s) on the allowable set of values, which satisfy(ies) the objective of the second optimization strategy.

In step 608, the N^{th} optimization strategy corresponding to the N^{th} optimization stage may be implemented. For example, the N^{th} optimization problem corresponding to the N^{th} optimization strategy may be solved. In certain embodiments, N may be 2 (e.g., there is no additional step 608 for another optimization stage after step 606, as in step 606 and step 608 are one and the same), or any other number based on the number of optimization stages selected by the operator in step 602. In certain embodiments, the process for step 608 may be similar to the process for steps 604 and 606, such that the N^{th} optimization strategy may have an associated optimization problem (e.g. based on an objective function, such as a function of one or more variables), and solving the optimization problem associated with the N^{th} optimization strategy may result in yet additional constraint(s) on the allowable set of values, which satisfy(ies) the objective of the N^{th} optimization strategy. In some embodiments, N may be 3, and the N^{th} optimization stage may be the final optimization stage. In some embodiments, when N is greater than 3 (e.g., where N=4, 5, or 6, etc.), step 608 may repeat for each of the subsequent optimization stages. Additional details regarding a given optimization stage (e.g., of step 604, 606, or 608) are described with respect to FIG. 6B.

In step 610, a plurality of operational parameters for the plurality of energy assets (e.g., of an EV charging network) may be determined based on the result of step 608 (e.g., a final optimization stage). The plurality of operational parameters may include, for example, one or more charging rates of one or more charging stations based on the constraint(s) resulting from the various optimization stages of steps 604, 606, and 608. In certain embodiments, the plurality of operational parameters for the plurality of energy assets may be a group of set-points for charging stations 112 of FIG. 1 and/or other energy assets (e.g., of the EV charging network), which may be stored locally (e.g., at the edge environment 102) and/or at the cloud environment 104 via one or more components thereof, as described herein with respect to, for example, FIG. 2 and FIG. 5, respectively. The group of set-points for charging stations 112 and/or other energy assets may correspond to a group of allowable values for the operational parameters for the charging stations 112 and/or other energy assets, such as, for example, charging rates, etc. These set-points may be determined based on, for example, multi-stage multi-objective optimizations as described herein (e.g., resulting in certain constraint(s)), where each set-point (e.g., each set of set-points) corresponds to a respective context (e.g., related to a number of available equipment and their associated types and/or properties, such as maximum charging rate, energy request amount, etc.). In certain embodiments, step 610 may include simply obtaining the resulting allowable set of values for certain operation parameters (e.g., charging rates of a charging station) from or after the final optimization stage (e.g., optimization stage N of step 608). In some embodiments, step 610 may further include performing one or more further calculations on the resulting allowable set of values for certain operation parameters from or after the final optimization stage. For example, the resulting allowable set of values for operational parameters from or after the final optimization stage may be parameters for a control loop, such as described as follows.

In certain embodiments, examples of operational parameters may include one or more of, but not be limited to: (1) charging or discharging set-points for a battery energy storage system or electric vehicle, (2) power set-points for a generator or fuel cell, (3) active/reactive power settings for an inverter such as on converting power from a solar PV system, (4) prices paid by EV driver for charging, (5) incentives given to EV driver, (6) guaranteed levels of energy that will be delivered during a session or of the time when the vehicle will finish charging, etc. Once a set-point is stored, it can be used to, for example: (1) monitor the expected behavior of the system including planned future behavior, (2) communicate expectations to drivers in terms of how their vehicles will charge, and/or (3) inform future rounds of optimization, for example, by requiring future optimizations not to deviate too much from the previous solution (e.g., “warm-starting” the algorithm for future optimization). One example of re-using the stored set-points would be caching the results of certain optimization stages, to mitigate the need to re-run them. For example, result(s) of (e.g., constraint(s) resulting from) M−1 optimization stages (where M is equal to or greater than 2) may be stored, for example, as a starting point for future optimizations. For example, constraint(s) resulting from one or more optimization stages (e.g., upto M−1 optimization stages) may be stored. A future optimization, where the first M−1 optimization strategies corresponding to a portion of a hierarchy of objectives of the future optimization are the same as the M−1 optimization stages that have already been performed, can then re-use the constraint(s) resulting from the previous run of M−1 optimization stages. The future optimization can then bypass the first M−1 optimization stages and start from stage M, resulting in increased speed/reduced delay (and potentially a more stable solution, as the set-points resulting from the future optimization may not deviate from the results of the previous optimization as much as they would potentially have if the M−1 optimization stages are re-run). These technical advantages may be realized by bypassing the processing or calculations from M−1 optimization stages in the future optimization.

In step 612, the plurality of energy assets may be controlled based on the plurality of operational parameters determined in the previous steps of process 600. For example, a plurality of charging stations may be controlled based on the charging rates determined in the previous steps of process 600. The plurality of operational parameters (e.g., charging rates) determined based on the constraints on the allowable set of operational parameters resulting from the previous steps of process 600 may be the optimized values for the plurality of operational parameters according to the plurality of objectives corresponding to the optimization strategies implemented in the previous steps of process 600.

FIG. 6B depicts additional details related to an optimization stage. In particular, FIG. 6B provides additional details of sub-steps 608A-608G of step 608 corresponding to optimization stage N. It should be noted that other optimization stages, such as represented by steps 604 and 606, may have similar sub-steps as shown for step 608.

As described herein, certain embodiments provide the capability for designing a multi-stage, multi-objective optimization problem using equipment, network, strategy, and persistence models. Equipment models may represent physical equipment on a site, such as EV charging stations, energy storage systems, and other energy assets such as, for example, meters for solar generation and building load. The equipment models may be saved as, for example, a JSON object, including one or more associated properties, such as equipment identification (ID), type of asset, nominal voltage value, phase, maximum number of charge sessions, maximum charging rate, minimum charging rate, default charging rate, incremental value for the charging rate, etc. Other types of data structures may also be possible to store information related to the equipment models.

Network models may represent the way the modeled equipment is supplied power, including any constraints in the electrical infrastructure (e.g., including one or more network nodes) such as, for example, breaker, wire, interconnection, and transformer limitations. For example, a network model may refer to a data structure, such as, for example, a JSON object including data related to a network node or device, such as breaker, wire, etc. For some embodiments, the network model may be referred to as a network object, and include information related to one or more constraints related to the network node (e.g., constraints on the allowable set of operational parameters for energy asset(s) of equipment models, such as maximum allowed charging rate due to constraints on power delivery due to network node limitations).

Strategy models may represent how energy assets such as distributed energy resources may be controlled. Each strategy model can include zero or more constraints and/or zero or more objective functions to be added for an optimization problem. For example, a strategy model may refer to a data structure, such as, for example, a JSON object including data related to an optimization strategy. For some embodiments, the strategy model may be referred to as a strategy object, and include information related to any constraint(s) and/or objective function(s) representative of the corresponding optimization strategy.

Persistence models may represent how one stage of optimization may interact with other stage(s) of optimization. These may include constraint(s) for one or more subsequent stages of optimization based on the solution of a previous stage of optimization. For example, a persistence model may refer to a data structure, such as, for example, a JSON object including data related to one or more constraints to maintain for subsequent optimization stage(s). For some embodiments, the persistence model may be referred to as a persistence object, and include information related to persistence object identification (ID) and the corresponding optimization strategy. In certain embodiments, the persistence object may be stored in a memory (e.g., persistence store).

Examples of JSON properties for equipment model may include one or more of, but not be limited to: maximum discharge rate (for V2X chargers and BESS) and battery size (in kWh). Examples of JSON properties for a network model may include one or more of, but not be limited to: network equipment connected to each network node, voltage of each network node, transformation in current and voltage caused by network nodes, such as transformers or other converters, and power and/or current limits of network nodes. Examples of JSON properties for a persistence model may include one or more of, but not be limited to: tolerances for how close an operational parameter/variable or a function must be to its target value from a previous optimization stage.

Each stage of optimization may share a common collection of equipment and network models. Each optimization stage then may include an optimization strategy or goal, which may be described or defined by one or more sub-strategies, as well as one or more persistence models representing how the result of this stage may affect subsequent stage(s). For example, each optimization stage may include a list of one or more sub-strategies corresponding to the optimization strategy or goal of the optimization stage. In some embodiments, each strategy (or sub-strategy) may result in zero or more constraints and an objective function (which may be 0). In addition, the optimization stage may include a list of zero or more persistence objects. Each persistence object may store information about the constraints related to one or more operational parameters (e.g., one or more variables) for the plurality of energy assets, which may be the result of solving (or generated by) the optimization problem of a previous optimization stage, such as optimal values for the one or more variables with respect to the previous optimization stage. These constraints may be included and taken into account in subsequent optimization stage(s). At the end of each optimization stage, the persistence object (e.g., persistence data) may be added to (stored in) a persistence store (e.g., a data structure configured to maintain a list of persistence objects), such that these constraints can be added to subsequent optimization problem(s) corresponding to the subsequent optimization stage(s). In some embodiments, a given optimization stage may include a list of zero or more persistence object identifications, corresponding to persistence object(s) which should be removed from the persistence store after the given stage is completed. For example, the constraint(s) corresponding to the persistence object(s) whose identifying information is to be removed from the persistence store after a given stage should not be added to any optimization problem of any subsequent stage(s). The list of such persistence object identifications (e.g., to be removed from the persistence store after a given stage) may be referred to as a “forget list.” Furthermore, each optimization stage may include shared equipment and network models, as well as shared optimization configurations and/or a list of zero or more shared strategies which apply to every stage. A forget list may be relevant when an allowable set of values for a given operational parameter or variable related to an energy asset may be fixed, and the persistence object corresponding to constraint(s) that resulted in this allowable set of values may no longer be needed or relevant (e.g., for subsequent stage(s)) and can be removed from the persistence store (“forgotten”). For example, limiting the cost of charging for a first subset of chargers may result in fixed charging rates (e.g., for the first subset of chargers), where this cost constraint may then be dropped before considering how to charge a second subset of chargers. Another example scenario for removing a persistence object may be where the constraint(s) related to this persistence object may no longer be relevant and may be violated. The forgotten persistence object may not be taken into account for subsequent optimization stage(s). One technical benefit from removing a persistence object from the persistence store may be reduced complexity of the overall optimization, resulting in improved performance or numerical stability, as compared to when this persistence object is still considered for future optimization stage(s).

Each persistence object and the persistence store may be maintained in any suitable data structure configured to maintain the information described herein. Further, each persistence object identification may be or include any suitable identifying information corresponding to the persistence object.

In certain embodiments, each persistence object may include at least two methods: a store method and a get method. The store method may process the solved optimization problem and store relevant details such as, for example, the value of an objective component or the power assigned to a particular piece of equipment. The get method may generate a list of one or more constraints which use information stored in the persistence object to provide one or more constraints for subsequent stage(s) of the optimization.

Referring now to step 608A, each optimization stage may begin by building a base optimization configuration using the shared models (e.g., shared equipment and network models, as well as shared optimization configurations and/or a list of zero or more shared strategies). For example, the base optimization configuration may include information related to minimum or maximum constraint(s) corresponding to one or more equipment (represented by corresponding equipment model(s)), one or more network nodes (represented by corresponding network model(s)), one or more shared strategies (represented by shared strategy model(s)), one or more shared optimization configurations, and/or the like. For example, the base optimization configuration may include a list of one or more constraints related to the shared information (e.g., shared equipment, network, and/or strategy model(s), as well as shared optimization configuration(s)), which may define a base allowable set of values for the one or more operational parameters of a plurality of energy assets. In certain embodiments, the shared models may include all the equipment on a site and all constraints related to the physical infrastructure. The shared strategies may include, for example, a restriction on the total power imported to the site from the utility grid. This strategy may be shared because it needs to be considered in every stage of the optimization. Shared strategies are considered in every stage to ensure feasibility of a given optimization problem. For example, the shared strategies may be related to physical limits, legal requirements, or customer preferences that are respected for every optimization stage. Stage-specific strategies may be utilized to gradually reduce the size of the allowable set of values for operational parameters until an optimal solution is achieved for a given use case. Examples of stage-specific strategies may include one or more of, but not be limited to: minimizing cost, minimizing delay, maximizing revenue, or equally sharing capacity. Strategies that are shared may include one or more of limiting power imported from the utility grid, limiting power exported to the utility grid, charging batteries or vehicles only from on-site solar generation, ensuring a minimum amount of power for each vehicle, etc.

In step 608B, the base optimization configuration of step 608A may be augmented by adding a stage-specific strategy (e.g., an optimization strategy added for a given optimization stage, defined by one or more objective functions, as described herein with respect to, for example, steps 604, 606, and 608 of FIG. 6A). For example, a stage-specific strategy may be to prioritize charging via a first charging station, defined by an objective function (e.g., a function of one or more variables, including a charging rate for the first charging station) for minimizing the delay for charging via the first charging station.

In step 608C, any persistence object(s) in the persistence store (e.g., including one or more constraints related, at least in part, to the plurality of operation parameters of the plurality of energy assets) may be added to the optimization stage to further define the optimization problem. For example, for the first optimization stage of a multi-stage, multi-objective optimization, the persistence store may be empty, since there would be no prior optimization stage, where any persistence object would have been added to the persistence store. For subsequent optimization stage(s) (e.g., a second stage, a third stage, or similar), the persistence store may include a persistence object from, for example, the first stage, which may include one or more constraints corresponding to the first stage, to apply for optimization for the subsequent optimization stage(s).

In step 608D, the optimization problem for each optimization stage may be built using the information included in steps 608A-608C. For example, the optimization problem may be a mathematical problem, solved programmatically, including one or more objective functions, as described herein, subject to one or more constraints discussed herein with respect to steps 608A-608C. As used herein, building an optimization problem may correspond to collecting (e.g., all) the objective components and constraints and transforming them into a standard form that a numerical solver can understand. For example, the constraint(s) may be related to the shared information (e.g., shared equipment, network, and/or strategy model(s), as well as shared optimization configuration(s), etc.), which may define a base allowable set of values for the one or more operational parameters of the plurality of energy assets (e.g., where the one or more operational parameters correspond to one or more variables of the one or more objective functions). The one or more objective functions may include, for example, an objective function related to a delay cost and/or a cost for charging related to a charging station, whose value (e.g., the delay cost or the cost for charging) is to be minimized (or maximized). Accordingly, the optimization problem may be built in the form of one or more objective functions of one or more variables, where the allowable set of values for the one or more variables may be subject to one or more constraints (e.g., those discussed herein with respect to steps 608A-608C).

In some embodiments, a shared context information may also be taken into account. The shared context information may provide information about the current state of the system which can be used in each stage. For example, the shared context information may include information related to the current state of an EV charging network, related to, for example, an amount or rate of charging already in progress (e.g., energy already delivered, latest measured current, requested energy amount, etc.). For example, the shared context information may be retrieved from the EV charging network via, for example, one or more components of edge environment 102 and/or one or more components of cloud environment 104, by gathering the current status of the energy assets (e.g., energy assets 114) of the EV charging network (e.g., site 110). In certain embodiments, the shared context information may also include one or more of energy prices, demand response events, driver preferences (e.g., amount of energy needed and deadlines), dynamic limits on vehicle or battery charging/discharging rates, dynamic limits on site power, etc. Accordingly, the shared base configuration may be “static” constraints (e.g., minimum or maximum constraints) based on inherent limitations related to equipment or network node(s), and the shared context information may be “dynamic” constraints based on the current status of a given site.

In step 608E, the problem built in steps 608A-608D is solved. For example, the problem built in steps 608A-608D may be a problem including one or more objective functions, subject to one or more constraints, as described herein, which may be solved programmatically by certain embodiments of the present disclosure.

In step 608F, the result of the problem solved in step 608E is processed to determine additional constraint(s) (e.g., which may be defined as part of additional persistence object(s)), to be added to the persistence store for subsequent optimization stage(s).

In step 608G, any persistence object(s), whose identifying information is/are included in the forget list, may be removed from the persistence store (e.g., before the next stage starts).

In some embodiments, one or more portions of each optimization stage (e.g., the optimization strategy, including any sub-strategy(ies), added for defining the optimization problem of each optimization) may be pre-defined (e.g., prior to being added to each optimization stage), such that, for example, the multi-stage, multi-objective optimization problem may be designed using a plurality of “building blocks” of the pre-defined optimization strategy(ies), enabling a modular solution to solving the optimization problem, rather than, for example, re-designing each optimization problem requiring a set of multiple objectives that may be achieved in a hierarchical manner.

FIG. 6C depicts an example flow diagram, providing additional details related to adding and/or removing persistence object(s) to and/or from the persistence store as described herein with respect to, for example, FIG. 6B.

As shown, in step 614 (corresponding to optimization stage 1), persistence object 1 (624) may be added to the persistence store 622. The forget list for optimization stage 1 is empty, and no persistence object may be removed from the persistence store 622. Accordingly, the persistence store 622 at the end of optimization stage 1 may include persistence object 1 (624). For example, the persistence object 1 (624) may include first identifying information of the persistence object 1 (624) and one or more constraints resulting from solving the objective function of optimization stage 1. Accordingly, in the subsequent optimization stage(s), the one or more constraints related to the objective function of optimization stage 1 may be retrieved (e.g., based on the first identifying information) and taken into consideration for solving the optimization problem of the subsequent optimization stage(s).

In step 616 (corresponding to optimization stage 2), persistence object 2 (626) may be added to the persistence store 622. The forget list for optimization stage 2 is empty, and no persistence object may be removed from the persistence store 622. Accordingly, the persistence store 622 at the end of optimization stage 2 may include persistence object 1 (624) and persistence object 2 (626). Persistence object 2 (626) may include second identifying information of the persistence object 2 (626) and one or more constraints resulting from solving the objective function of optimization stage 2. Accordingly, in the subsequent optimization stage(s), the one or more constraints related to the objective function of optimization stage 1 and the one or more constraints related to the objective function of optimization stage 2 may be retrieved (e.g., based on the first identifying information and the second identifying information) and taken into consideration for solving the optimization problem of the subsequent optimization stage(s).

In step 618 (corresponding to optimization stage 3), persistence object 3 (628) may be added to the persistence store 622. The forget list for optimization stage 3 includes identifying information for persistence object 1 (624), and thus, persistence object 1 (624) may be removed from the persistence store 622 as part of optimization stage 3 (e.g., before or after optimization stage 3). Accordingly, the persistence store 622 at the end of optimization stage 3 may include persistence object 2 (626) and persistence object 3 (628), but not persistence object 1 (624). Persistence object 3 (628) may include third identifying information of the persistence object 3 (628) and one or more constraints resulting from solving the objective function of optimization stage 3. Accordingly, in the subsequent optimization stage(s), the one or more constraints related to the objective function of optimization stage 2 and the one or more constraints related to the objective function of optimization stage 3 may be retrieved (e.g., based on the second identifying information and the third identifying information) and taken into consideration for solving the optimization problem of the subsequent optimization stage(s). The constraint(s) related to the objective function of optimization stage 1 would no longer affect the optimization of the subsequent optimization stage(s).

In step 620 (corresponding to optimization stage N), no persistence object is added or removed. Thus, the persistence store 622 at the end of optimization stage N may include persistence object 2 (626) and persistence object 3 (628), as well as any persistence object (630) which may have been added as part of an optimization stage between optimization stage 3 and optimization stage N. It would be apparent to one of ordinary skill in the art that the content of the persistence store 622 may be updated based on any persistence object(s) that is/are added or removed as part of a given optimization stage.

Referring back to the example scenario described with respect to FIG. 6A (e.g., step 602), a base optimization configuration for the optimization may be determined based on network model (based on limitations related to network infrastructure of a given site) and a list of equipment models (based on limitations related to energy assets on the given site), for example, as part of step 608A described with respect to FIG. 6B.

The first objective of the example hierarchy of objectives of the example scenario may be described as allocating minimum power to each charger. This objective may be achieved as part of a first optimization stage (e.g., step 604 of FIG. 6A), where its optimization strategy may be to penalize charging below minimum power. Thus, a corresponding objective function (e.g., a cost function related to penalizing charging below minimum power) may be used for defining the optimization problem for this stage (step 608B of FIG. 6B). With persistence store being empty to start (step 608C of FIG. 6B), an optimization problem based on the objective function may be built (step 608D of FIG. 6B), and then solved, for example, programmatically (step 608E of FIG. 6B). Then, any constraint(s) on operational parameter(s), such as charging rates, etc., resulting from solving the optimization problem of this optimization stage, may be added to persistence store as part of a persistence object (step 608F of FIG. 6B).

The second objective of the example hierarchy of objectives of the example scenario may be described as allocating as much of the remaining capacity to DCFC chargers (a first group) as possible. This objective may be achieved as part of a second optimization stage (e.g., step 606 of FIG. 6A), where its optimization strategy may be to minimize charging delay cost (e.g., applied only to DCFC chargers in the first group). Thus, a corresponding objective function (e.g., a cost function related to penalizing delay in charging DCFC chargers in the first group) may be used for defining the optimization problem for this stage (step 608B of FIG. 6B). The persistence object added in the first optimization stage may be accessed from the persistence store to retrieve any relevant constraint(s) to apply to the objective function of the second optimization stage (step 608C of FIG. 6B). Then, an optimization problem based on the objective function (e.g., a cost function related to penalizing delay in charging DCFC chargers in the first group) and the retrieved constraint(s) may be built (step 608D of FIG. 6B), and then solved, for example, programmatically (step 608E of FIG. 6B). Then, any constraint(s) on operational parameter(s), such as charging rates, etc., resulting from solving the optimization problem of this optimization stage, may be added to persistence store as part of another persistence object (step 608F of FIG. 6B). For example, any relevant constraint related to the minimized charging delay cost objective value may be stored as a persistence object, where this persistence object may be identified as a corresponding identifying information (e.g., “P1”).

The third objective of the example hierarchy of objectives of the example scenario may be described as equally sharing charging capacity amongst the DCFC chargers of the first group so long as it does not increase the total delay. This objective may be achieved as part of a third optimization stage (e.g., step 608 of FIG. 6A), where its optimization strategy may be to perform quadratic regularization to determine charging rates for the DCFC chargers of the first group. Thus, a corresponding objective function (sum; sum, rᵢ(t)², where t is the index of an interval, and rᵢ(t) is the charging rate of vehicle i at interval t) may be used for defining the optimization problem for this stage (step 608B of FIG. 6B). The persistence objects added in the first and second optimization stages may be accessed from the persistence store to retrieve any relevant constraint(s) to apply to the objective function of the third optimization stage (step 608C of FIG. 6B). Then, an optimization problem based on the objective function and the retrieved constraint(s) may be built (step 608D of FIG. 6B), and then solved, for example, programmatically (step 608E of FIG. 6B). Then, any constraint(s) on operational parameter(s), such as charging rates, etc., resulting from solving the optimization problem of this optimization stage, may be added to persistence store as part of another persistence object (step 608F of FIG. 6B). For example, any relevant constraint related to the fixed charging rates of the DCFC chargers of the first group may be stored as another persistence object. Further, since the charging rates for the DCFC chargers of the first group are fixed at this point, the persistence object (identified as P1), which was used for determining the charging rates for the DCFC chargers of the first group, may not be useful for subsequent optimization stages. Thus, P1 (identifying information of the persistence object added in the second optimization stage) may be included in a forget list for persistence objects to be removed, and based on P1 being included in the forget list, the persistence object identified as P1 may be removed from the persistence store (step 608G of FIG. 6B).

The fourth objective of the example hierarchy of objectives of the example scenario may be described as allocating as much of the remaining capacity to fleet chargers (a second group) as possible. This objective may be achieved as part of a fourth optimization stage (e.g., another instance of step 608 of FIG. 6A), where its optimization strategy may be to minimize charging delay cost (e.g., applied only to fleet chargers in the second group). Thus, a corresponding objective function (e.g., a cost function related to penalizing delay in charging fleet chargers in the second group) may be used for defining the optimization problem for this stage (step 608B of FIG. 6B). The persistence objects added in the first and third optimization stages may be accessed from the persistence store to retrieve any relevant constraint(s) to apply to the objective function of the fourth optimization stage (step 608C of FIG. 6B). Since the persistence object identified as P1 was removed in the third optimization stage, it is no longer available in the persistence store, to be considered in the fourth optimization stage. Then, an optimization problem based on the objective function (e.g., a cost function related to penalizing delay in charging fleet chargers in the second group) and the retrieved constraint(s) (e.g., related to the fixed charging rates of DCFC chargers of the first group, as determined in the third optimization stage) may be built (step 608D of FIG. 6B), and then solved, for example, programmatically (step 608E of FIG. 6B). Then, any constraint(s) on operational parameter(s), such as charging rates, etc., resulting from solving the optimization problem of this optimization stage, may be added to persistence store as part of another persistence object (step 608F of FIG. 6B). For example, any relevant constraint related to the minimized charging delay cost objective value may be stored as a persistence object.

The fifth objective of the example hierarchy of objectives of the example scenario may be described as equally sharing charging capacity amongst the fleet chargers of the second group. This objective may be achieved as part of a fifth optimization stage (e.g., another/final instance of step 608 of FIG. 6A), where its optimization strategy may be to perform quadratic regularization to determine charging rates for the fleet chargers of the second group. Thus, a corresponding objective function (such as described above with respect to the third objective) may be used for defining the optimization problem for this stage (step 608B of FIG. 6B). The persistence objects added in the first, third, and fourth optimization stages may be accessed from the persistence store to retrieve any relevant constraint(s) to apply to the objective function of the fifth optimization stage (step 608C of FIG. 6B). Similarly as in the fourth optimization stage, since the persistence object identified as P1 was removed in the third optimization stage, the P1 persistence object is no longer available in the persistence store, to be considered in the fifth optimization stage. Then, an optimization problem based on the objective function and the retrieved constraint(s) may be built (step 608D of FIG. 6B), and then solved, for example, programmatically (step 608E of FIG. 6B).

Then, the results of the fifth optimization stage (e.g., final optimization stage) may be used to determine a plurality of operational parameters for energy assets (e.g., DCFC chargers of the first group, fleet chargers of the second group, etc.) (step 610 of FIG. 6A). In some scenarios, the results of the final optimization stage may be obtained to use as the operational parameters for energy assets. In some scenarios, as described with respect to FIG. 6A, step 610 may also include additional processing or calculations.

The determined operational parameters of energy assets may then be used to control, for example, DCFC chargers of the first group and fleet chargers of the second group (step 612 of FIG. 6A).

The process 600 of solving a multi-stage, multi-objective optimization problem described herein with respect to FIGS. 6A-6C may be further described, as follows.

A generalized optimization problem may be defined by notation (1):

$$\begin{matrix}{min}_{x} f ( x , y ) \\ s . t . x ∈\end{matrix} \qquad ( 1 )$$

where ƒ(x, y) is the objective function which, for example, needs to be minimized, x is the collection of optimization variables (e.g., operational parameters of a plurality of energy assets, such as the charging rate of charging station 112 of site 110), y is the collection of problem parameters, and [symbol] is the allowable set of the optimization variables x which may depend on the collection of problem parameters γ. One example of the problem parameter may be the maximum charging rate of a charging station. The allowable set [symbol] encodes the charging rate of a charging station, which must be less than this maximum charging rate. Another example may be capacity of a battery. The allowable set A encodes the energy stored in a battery, which may be greater than or equal to a minimum value and less than or equal to the capacity of the battery. Moreover, the allowable set may encode that the charging rate of a charging station when no vehicle is connected must equal 0. It would be apparent to one of ordinary skill in the art that, without loss of generality, this can also represent the maximization of a function by negating the objective function. The methods described herein are not specific to convex problems, such that the objective function ƒ(x) and the allowable set [symbol] may be non-convex. For example, the objective function could have local minima or the set [symbol] may be discrete, consist of disjoint sets, or be otherwise non-convex. In the case where the optimization problem is non-convex, the results from each stage may include a sub-optimal solution which meets a stopping criteria such as being within some tolerance of the global optima or which may be the best solution within a given time or compute budget. In some cases, the solution to the optimization may be approximated by a heuristic algorithm including, but not limited to, machine learning methods. The allowable set of the optimization variables may correspond to the plurality of operational parameters (e.g., charging rate, etc.) being optimized for a plurality of energy assets (e.g., charging station 112) of a given EV charging network (e.g., site 110).

Then, problem data (e.g., relevant data that describe a given optimization problem-such as an objective function of one or more optimization variables, one or more problem parameters, and the allowable set of values for the optimization variables) which describes the optimization problem may be denoted as:

$$P := ( f ( x , y ) , y , ) . \qquad ( 2 )$$

As described herein, the optimization problem may be defined by a plurality of “building blocks” of strategies. For example, the set of all strategies in the problem may be denoted as [symbol] , and each individual strategy may be denoted as [symbol] ⱼ. [symbol] ⱼ can be considered a tuple of an objective function ƒⱼ(x, y) and an allowable set [symbol] ⱼ. At this point, ƒⱼ(x, y) is a general function and [symbol] ⱼ is a general set, neither of which is required to be convex. The objective function ƒⱼ(x, y) may itself be arbitrarily complex. For example, it may be described by the sum of multiple other functions. Likewise, the allowable set [symbol] ⱼ may be described by a collection of constraints (though not required).

In certain embodiments, some strategies may not add any additional constraint to the allowable set of values, and may not narrow the allowable set of values. For example, these strategies may not affect the allowable set of optimization variables (e.g., charging rate of a given charging station, such as charging station 112). For these strategies, which do not need to restrict the allowable set, [symbol] ⱼ= [symbol] (e.g., a set of all numbers). In some embodiments, some example types of strategies include, but are not limited to: (1) strategies with an objective function but no constraints; (2) strategies with no objective function but with constraints; and (3) strategies with both an objective function and constraints.

The set of all equipment included in the EV charging network (e.g., energy assets 114 of FIG. 1) may be denoted as E, and each individual node as εⱼ. Like strategies, equipment may be modeled as a tuple of an objective function ƒᵢ(x, y) and an allowable set [symbol] ᵢ.

The set of all network nodes (e.g., network devices in the electrical infrastructure by which the energy assets 114 may be supplied power, such as, for example, breaker, wire, etc.) may be denoted as [symbol] , and each individual node as [symbol] ₖ. Like strategies and equipment, network nodes may be modeled as a tuple of an objective function ƒₖ(x, y) and an allowable set [symbol] ₖ.

For a problem with multiple strategies, equipment, and/or network nodes, the objective components may be combined as ƒ(x, y)= [symbol] ƒₘ(x, y), and the intersection of the allowable sets may be taken into account, for example, [symbol] = [symbol] [symbol] ₘ, where [symbol] is the set of all models (e.g., strategies, equipment, and network nodes) in this optimization problem.

Certain embodiments of the present disclosure describe a multi-stage model whereby a sequence of optimization problems may be solved to arrive at a solution which solves an underlying problem, which may be difficult or impossible to describe as a single-stage problem, as described herein.

Within each stage of the multi-stage optimization, an optimization problem may be defined as P^{(s)}, where s is the stage number. P^{(s)} may be formed via a collection of strategy, equipment, and network node models. The sets of equipment, ε, and network nodes, [symbol] , may be constant across stages, such that they are not dependent on s. Likewise, the parameters y may be independent of s. However, the set of strategies may depend on the stage. For each stage, there may be two sets of strategies, [symbol] ⁰ which is the set of strategies shared amongst all stages, and [symbol] ^{(s)} which is the set of strategies specific to this stage of the optimization.

Further, the persistence models (e.g., saved as persistence objects, as described herein with respect to, for example, FIGS. 6A-6C) may be described, as follows. Persistence models may be designed to add memory to the problem sequence. Persistence models may not have objective components. However, they may restrict the allowable set. The restriction on the allowable set may be dependent on the problem data and optimal solution of each stage. This means that for a persistence model added in stage s, its allowable set [symbol] ₗ is a function of P^{(s)} and its optimal solution x^{(s)}*.

Persistence models may apply to all subsequent stages s+1, . . . . N, unless they are specifically removed at some future stage (e.g., by having their identifying information included in the forget list).

Following, a multi-stage problem may then be described as a collection of single-stage problems which are linked via persistence models. If a multi-stage problem may be denoted as M, then M:=(P⁽¹⁾, P⁽²⁾, . . . , P^{(N)}) where N is the number of stages.

In optimization stage 1, the first optimization problem may be built, as follows:

$${P}^{( 1 )} = ( {f}^{( 1 )} ( x , y ) , y , {( 1 )}^{} ) \qquad ( 3 )$$

where:

$${f}^{( 1 )} ( x , y ) = {\sum }_{i ∈ ℰ} {f}_{i} ( x , y ) + {\sum }_{j ∈ {𝒮}^{0}} {f}_{j} ( x , y ) + {\sum }_{j ∈ {𝒮}^{( 1 )}} {f}_{j} ( x , y ) + {\sum }_{k ∈ 𝒩} {f}_{k} ( x , y ) \qquad ( 4 )$$

$$and$$

$${( 1 )}^{} = {⋂}_{i ∈ ℰ} {i}_{} ⋂ {⋂}_{j ∈ {𝒮}^{0}} {j}_{} ⋂ {⋂}_{j ∈ {𝒮}^{( 1 )}} {j}_{} ⋂ {⋂}_{k ∈ 𝒩} {k}_{} . \qquad ( 5 )$$

Since many of these terms are not dependent on the stage number, for simplification, the part of the objective function which is independent of the stage may be denoted as ƒ⁰(x, y)=Σ_{i∈ε}ƒᵢ(x, y)+ [symbol] ƒⱼ(x, y)+ [symbol] ƒₖ(x, y), and the allowable set which is independent of the stage as [symbol] ⁰=∩_{i∈ε} [symbol] ᵢ∩∩_{j∈s}_{⁰} [symbol] ⱼ∩ [symbol] [symbol] ₖ. Accordingly, for optimization stage 1:

$${f}^{( 1 )} ( x , y ) = {f}^{0} ( x , y ) + {\sum }_{j ∈ {𝒮}^{( 1 )}} {f}_{j} ( x , y ) \qquad ( 6 )$$

$${( 1 )}^{} = {0}^{} ⋂ {⋂}_{j ∈ {𝒮}^{( 1 )}} {j}_{} . \qquad ( 7 )$$

The set of persistence models added at optimization stage 1 may be denoted as [symbol] ⁽¹⁾. The allowable sets for these persistence strategies (e.g., strategies corresponding to the persistence objects stored in the persistence store at a given optimization stage, such as optimization stage 1 in this example) can be calculated using the problem data P⁽¹⁾ and the optimal solution from stage 1, x⁽¹⁾*.

In optimization stage 2, the problem P⁽²⁾ may be solved, where

$${f}^{( 2 )} ( x , y ) = {f}^{0} ( x , y ) + {\sum }_{j ∈ {𝒮}^{( 2 )}} {f}_{j} ( x , y ) \qquad ( 8 )$$

$$and$$

$$= {0}^{} ⋂ {⋂}_{j ∈ {𝒮}^{( 2 )}} {j}_{} ⋂ {⋂}_{l ∈ {𝒫}^{( 1 )}} {l}_{} . \qquad ( 9 )$$

Then, P⁽²⁾ may be solved to calculate the allowable sets for persistence strategies in [symbol] ⁽²⁾. The forget set (e.g., forget list) for stage s may be denoted as [symbol] ^{(s)}. Any persistence model in the forget set at stage s may be excluded from contributing to the allowable set during, for example, stage s+1 and all subsequent stages. In certain embodiments, the forget set may be applied at the beginning of each stage, and may be excluded from contributing to the allowable set even during the current stage, s. The [symbol] ^{(s)} may include any persistence model in

$${⋃}_{γ = 1}^{s - 1} {𝒫}^{( γ )} .$$

Accordingly, a general form for the problem at stage s may be denoted as:

$${f}^{( s )} ( x , y ) = {f}^{0} ( x , y ) + {\sum }_{j ∈ {𝒮}^{( s )}} {f}_{j} ( x , y ) \qquad ( 10 )$$

$$and$$

$${( s )}^{} = {0}^{} ⋂ {⋂}_{j ∈ {𝒮}^{( s )}} {j}_{} ⋂ {⋂}_{l ∈ {⋃}_{γ = 1}^{s - 1} {𝒫}^{( γ )} \backslash {⋃}_{γ = 1}^{s - 1} {ℱ}^{( γ )}} {l}_{} \qquad ( 11 )$$

where

$$l ∈ {⋃}_{γ = 1}^{s - 1} {𝒫}^{( γ )} \backslash {⋃}_{γ = 1}^{s - 1} {ℱ}^{( γ )}$$

describes all the persistence strategies added up to stage s−1 excluding those forgotten in stage s−1 and all previous stages.

Then, the solution to the final problem P⁽ⁿ⁾ which may be denoted as x⁽ⁿ⁾* is the value which will be used to control the plurality of assets of the EV charging network.

### Example Method of Performing Multi-Stage, Multi-Objective Optimization

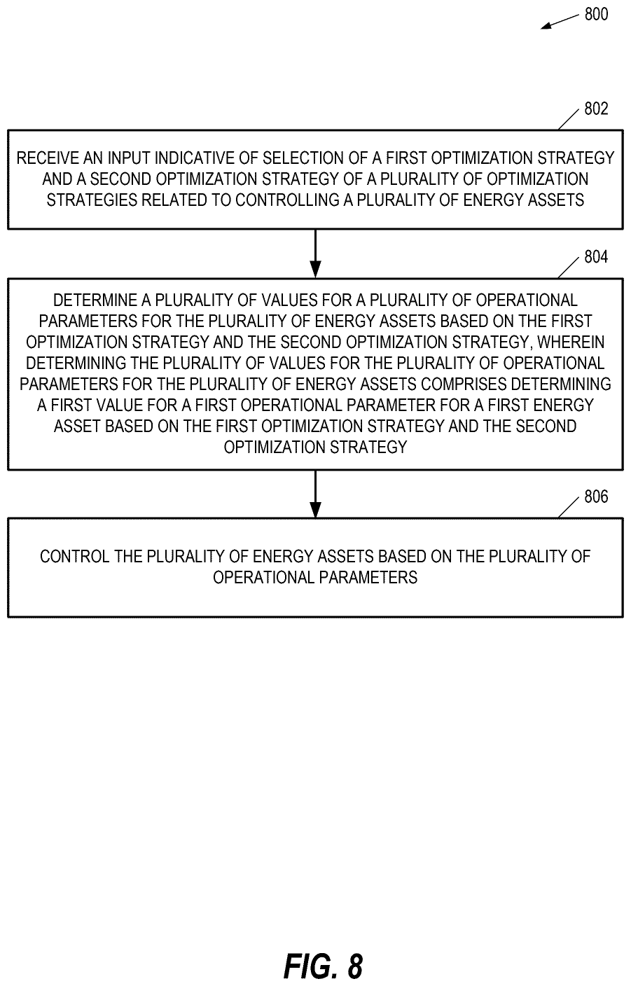

Referring now to FIG. 8, a method 800 related, at least in part, to the description of process 600 with respect to FIGS. 6A-6C is described. The method 800 may be performed by a core device 302 of FIG. 3, for example, by utilizing one or more components of edge environment 102 described herein with respect to FIG. 2 (e.g., the optimization and control manager 203 of FIG. 2) and/or one or more components of cloud environment 104 described herein with respect to FIG. 5 (e.g., the APIs 514 of FIG. 5, such as the optimization and control API 525).

In step 802, the method 800 may include receiving an input indicative of selection of a first optimization strategy and a second optimization strategy of a plurality of optimization strategies related to controlling a plurality of energy assets.

In step 804, the method 800 may include determining a plurality of values for a plurality of operational parameters for the plurality of energy assets based on the first optimization strategy and the second optimization strategy, wherein determining the plurality of values for the plurality of operational parameters for the plurality of energy assets may include determining a first value for a first operational parameter for a first energy asset based on the first optimization strategy and the second optimization strategy. For example, the first value for the first operational parameter may be a value for charging rate of a given charging station, which is optimized based on the first optimization strategy, and then the second optimization strategy.

In some embodiments, determining the plurality of values may further include: determining a first set of values for the plurality of operational parameters based on the first optimization strategy, wherein the first set of values is associated with a first cost related to the first optimization strategy; determining a second set of values for the plurality of operational parameters based on: the second optimization strategy; and one or more of: 1) one or more values of the first set of values, or 2) the first cost, wherein the second set of values is associated with a second cost related to the second optimization strategy; and determining the plurality of values based on the second set of values. In certain examples, the input may be further indicative of selection of a third optimization strategy of the plurality of optimization strategies, and determining the plurality of values may further include: determining a third set of values for the plurality of operational parameters based on: the third optimization strategy; the one or more of: 1) the one or more values of the first set of values, or 2) the first cost; and one or more of: 1) one or more values of the second set of values, or 2) the second cost, wherein the third set of values is associated with a third cost related to the third optimization strategy; and determining the plurality of values based on the third set of values.

In certain embodiments, the method 800 may further include: storing persistence data including first identifying information corresponding to the one or more of: 1) the one or more values of the first set of values, or 2) the first cost; and adding, to the persistence data, second identifying information corresponding to the one or more of: 1) the one or more values of the second set of values, or 2) the second cost, wherein determining the third set of values includes: identifying the one or more of: 1) the one or more values of the first set of values, or 2) the first cost, based on the persistence data; and identifying the one or more of: 1) the one or more values of the second set of values, or 2) the second cost, based on the persistence data.

In some embodiments, the input may be further indicative of selection of a third optimization strategy of the plurality of optimization strategies, and determining the plurality of values may further include: determining a third set of values for the plurality of operational parameters based on: the third optimization strategy; and one or more of: 1) one or more values of the second set of values, or 2) the second cost, wherein the third set of values is associated with a third cost related to the third optimization strategy; and determining the plurality of values based on the third set of values. In some examples, the method 800 may also include: storing persistence data including first identifying information corresponding to the one or more of: 1) the one or more values of the first set of values, or 2) the first cost, after determining the first set of values; and after determining the second set of values: adding, to the persistence data, second identifying information corresponding to the one or more of: 1) the one or more values of the second set of values, or 2) the second cost; and removing, from the persistence data, the first identifying information, wherein: determining the third set of values includes: identifying the one or more of: 1) the one or more values of the second set of values, or 2) the second cost, based on the persistence data.

In certain embodiments, determining the first set of values may include solving a first optimization problem corresponding to the first optimization strategy, the first optimization problem including minimizing or maximizing one or more first objective functions. In some examples, at least one of the one or more first objective functions may be a convex function. In some examples, at least one of the one or more first objective functions may be a non-convex function.

In some embodiments, the plurality of energy assets may include at least one electrical vehicle supply equipment (EVSE), and the plurality of operational parameters may include a charging rate for the at least one EVSE.

In certain embodiments, the plurality of energy assets may include at least one energy storage device, and the plurality of operational parameters may include a charge or discharge amount (e.g., a charge amount or a discharge amount) for the at least one energy storage device.

In some embodiments, the plurality of energy assets may include one or more of: one or more EVSEs, one or more battery energy storage systems, one or more heat batteries, one or more solar photovoltaic (PV) systems, one or more generators, one or more fuel cells, one or more Heating, Ventilation, and Air Conditioning (HVAC) systems, one or more lighting controls, or one or more water heaters.

In step 806, the method 800 may include controlling the plurality of energy assets based on the plurality of operational parameters.

In certain embodiments, the method 800 may also include providing a user interface (e.g., user interface 702 of FIG. 7) for receiving one or more user inputs corresponding to the input.

### Example Processing System for Multi-Stage, Multi-Objective Optimization

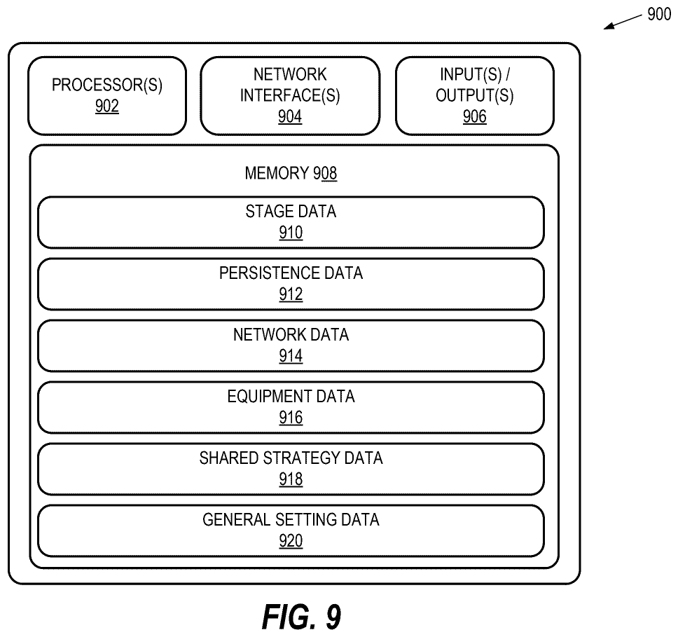

FIG. 9 depicts an example processing system 900 configured to perform the methods described herein.

In various embodiments, processing system 900 shown in FIG. 9 may be implemented on, e.g., the core device 302 of FIG. 3.

As shown, processing system 900 may include one or more processors 902. Generally, the one or more processors 902 may be configured to execute computer-executable instructions (e.g., software code) to perform various functions, as described herein.

Processing system 900 may further include one or more network interfaces 904, which generally provide data access to any sort of data network, including personal area networks (PANs), local area networks (LANs), wide area networks (WANs), the internet, and the like.

Moreover, processing system 900 may include input(s) and output(s) 906, which generally provide means for providing data to and from processing system 900, such as via connection to computing device peripherals, including user interface peripherals.

Processing system 900 may also include one or more memories 908 comprising various components. In this example, the one or more memories 908 include stage data 910, persistence data 912, network data 914, equipment data 916, shared strategy data 918, and general setting data 920.

The stage data 910 may include stage-specific data described herein with respect to, for example, FIGS. 6A-6C. For example, the stage data 910 may include stage-specific strategy data (e.g., definition or implementation of the stage-specific strategy, as well as relevant parameter(s) and/or constraint(s)).

The persistence data 912 may include the data corresponding to the persistence store described herein with respect to, for example, FIGS. 6A-6C. As described herein with respect to certain embodiments, the persistence store may maintain identifying information of one or more persistence data (e.g., related to constraints on operational parameters of energy assets, resulting from an optimization stage).

The network data 914 may include data related to the network node(s) (e.g., network model(s)) described herein with respect to, for example, FIGS. 6A-6C.

The equipment data 916 may include data related to the equipment, such as energy assets and charging stations (e.g., equipment model(s)) described herein with respect to, for example, FIGS. 6A-6C.

The shared strategy data 918 may include data related to one or more shared strategies (e.g., definition or implementation of the shared strategy(ies), as well as relevant parameter(s) and/or constraint(s)) described herein with respect to, for example, FIGS. 6A-6C.

The general setting data 920 may include, for example, data related to the base configuration used for each optimization stage, described herein with respect to, for example, FIGS. 6A-6C.

Processing system 900 may be implemented in various ways. For example, processing system 900 may be implemented as a computing device 402 within a core device 302, described herein with respect to FIGS. 3 and 4. In various embodiments, one or more aspects may be omitted from, added to, or substituted from processing system 900.

### Example Clauses

Implementation examples are described in the following numbered clauses:

Clause 1: A method, comprising: receiving an input indicative of selection of a first optimization strategy and a second optimization strategy of a plurality of optimization strategies related to controlling a plurality of energy assets; determining a plurality of values for a plurality of operational parameters for the plurality of energy assets based on the first optimization strategy and the second optimization strategy, wherein determining the plurality of values for the plurality of operational parameters for the plurality of energy assets comprises determining a first value for a first operational parameter for a first energy asset based on the first optimization strategy and the second optimization strategy; and controlling the plurality of energy assets based on the plurality of operational parameters.

Clause 2: The method in accordance with clause 1, wherein determining the plurality of values further comprises: determining a first set of values for the plurality of operational parameters based on the first optimization strategy, wherein the first set of values is associated with a first cost related to the first optimization strategy; determining a second set of values for the plurality of operational parameters based on: the second optimization strategy; and one or more of: 1) one or more values of the first set of values, or 2) the first cost, wherein the second set of values is associated with a second cost related to the second optimization strategy; and determining the plurality of values based on the second set of values.

Clause 3: The method in accordance with clause 2, wherein: the input is further indicative of selection of a third optimization strategy of the plurality of optimization strategies; and determining the plurality of values further comprises: determining a third set of values for the plurality of operational parameters based on: the third optimization strategy; the one or more of: 1) the one or more values of the first set of values, or 2) the first cost; and one or more of: 1) one or more values of the second set of values, or 2) the second cost, wherein the third set of values is associated with a third cost related to the third optimization strategy; and determining the plurality of values based on the third set of values.

Clause 4: The method in accordance with clause 3, further comprising: storing persistence data comprising first identifying information corresponding to the one or more of: 1) the one or more values of the first set of values, or 2) the first cost; and adding, to the persistence data, second identifying information corresponding to the one or more of: 1) the one or more values of the second set of values, or 2) the second cost; wherein: determining the third set of values comprises: identifying the one or more of: 1) the one or more values of the first set of values, or 2) the first cost, based on the persistence data; and identifying the one or more of: 1) the one or more values of the second set of values, or 2) the second cost, based on the persistence data.

Clause 5: The method in accordance with any one of clauses 2-4, wherein: the input is further indicative of selection of a third optimization strategy of the plurality of optimization strategies; and determining the plurality of values further comprises: determining a third set of values for the plurality of operational parameters based on: the third optimization strategy; and one or more of: 1) one or more values of the second set of values, or 2) the second cost, wherein the third set of values is associated with a third cost related to the third optimization strategy; and determining the plurality of values based on the third set of values.

Clause 6: The method in accordance with clause 5, further comprising: storing persistence data comprising first identifying information corresponding to the one or more of: 1) the one or more values of the first set of values, or 2) the first cost, after determining the first set of values; and after determining the second set of values: adding, to the persistence data, second identifying information corresponding to the one or more of: 1) the one or more values of the second set of values, or 2) the second cost; and removing, from the persistence data, the first identifying information; wherein: determining the third set of values comprises: identifying the one or more of: 1) the one or more values of the second set of values, or 2) the second cost, based on the persistence data.

Clause 7: The method in accordance with any one of clauses 2-6, wherein determining the first set of values comprises solving a first optimization problem corresponding to the first optimization strategy, the first optimization problem comprising minimizing or maximizing one or more first objective functions.

Clause 8: The method in accordance with clause 7, wherein at least one of the one or more first objective functions is a convex function.

Clause 9: The method in accordance with any one of clauses 7-8, wherein at least one of the one or more first objective functions is a non-convex function.

Clause 10: The method in accordance with any one of clauses 1-9, wherein: the plurality of energy assets comprise at least one electric vehicle supply equipment (EVSE); and the plurality of operational parameters comprise a charging rate for the at least one EVSE.

Clause 11: The method in accordance with any one of clauses 1-10, wherein: the plurality of energy assets comprise at least one energy storage device; and the plurality of operational parameters comprise a charge or discharge amount for the at least one energy storage device.

Clause 12: The method in accordance with any one of clauses 1-11, wherein the plurality of energy assets comprise one or more of: one or more EVSEs, one or more battery energy storage systems, one or more heat batteries, one or more solar photovoltaic (PV) systems, one or more generators, one or more fuel cells, one or more Heating, Ventilation, and Air Conditioning (HVAC) systems, one or more lighting controls, or one or more water heaters.

Clause 13: The method in accordance with any one of clauses 1-12, further comprising providing a user interface for receiving one or more user inputs corresponding to the input.

Clause 14: A processing system, comprising: one or more memories comprising computer-executable instructions; and one or more processors configured to execute the computer-executable instructions and cause the processing system to perform a method in accordance with any one of clauses 1-13.

Clause 15: A processing system, comprising means for performing a method in accordance with any one of clauses 1-13.

Clause 16: A non-transitory computer-readable medium storing program code for causing a processing system to perform the steps of any one of clauses 1-13.

Clause 17: A computer program product embodied on a computer-readable storage medium comprising code for performing a method in accordance with any one of clauses 1-13.

Clause 18: A processing system, comprising: one or more memories; and one or more processors, coupled to the one or more memories, configured to cause the processing system to perform a method in accordance with any one of clauses 1-13.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) (logic) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a memory,” “the processor,” “the memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., a system) to perform functions, one element may be configured to cause the other element to perform all functions, or more than one element may collectively be configured to cause the other element to perform the functions. Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein include systems, methods, and non-transitory computer-readable mediums corresponding to, for example, multi-stage, multi-objective optimization for controlling a plurality of energy assets. It should also be understood that these embodiments are merely exemplary and are not intended to limit the scope of this disclosure.

What is claimed is:

1. A method, comprising:
receiving an input indicative of selection of a first optimization strategy and a second optimization strategy of a plurality of optimization strategies related to controlling a plurality of energy assets;
determining a plurality of values for a plurality of operational parameters for the plurality of energy assets based on the first optimization strategy and the second optimization strategy, wherein determining the plurality of values for the plurality of operational parameters for the plurality of energy assets comprises determining a first value for a first operational parameter for a first energy asset based on the first optimization strategy and the second optimization strategy; and
controlling the plurality of energy assets based on the plurality of operational parameters.

2. The method of claim 1, wherein determining the plurality of values further comprises:
determining a first set of values for the plurality of operational parameters based on the first optimization strategy, wherein the first set of values is associated with a first cost related to the first optimization strategy;
determining a second set of values for the plurality of operational parameters based on:
the second optimization strategy; and
one or more of: 1) one or more values of the first set of values, or 2) the first cost,
wherein the second set of values is associated with a second cost related to the second optimization strategy; and
determining the plurality of values based on the second set of values.

3. The method of claim 2, wherein:
the input is further indicative of selection of a third optimization strategy of the plurality of optimization strategies; and
determining the plurality of values further comprises:
determining a third set of values for the plurality of operational parameters based on:
the third optimization strategy;
the one or more of: 1) the one or more values of the first set of values, or 2) the first cost; and
one or more of: 1) one or more values of the second set of values, or 2) the second cost,
wherein the third set of values is associated with a third cost related to the third optimization strategy; and
determining the plurality of values based on the third set of values.

4. The method of claim 3, further comprising:
storing persistence data comprising first identifying information corresponding to the one or more of: 1) the one or more values of the first set of values, or 2) the first cost; and
adding, to the persistence data, second identifying information corresponding to the one or more of: 1) the one or more values of the second set of values, or 2) the second cost;
wherein:
determining the third set of values comprises:
identifying the one or more of: 1) the one or more values of the first set of values, or 2) the first cost, based on the persistence data; and
identifying the one or more of: 1) the one or more values of the second set of values, or 2) the second cost, based on the persistence data.

5. The method of claim 2, wherein:
the input is further indicative of selection of a third optimization strategy of the plurality of optimization strategies; and
determining the plurality of values further comprises:
determining a third set of values for the plurality of operational parameters based on:
the third optimization strategy; and
one or more of: 1) one or more values of the second set of values, or 2) the second cost,
wherein the third set of values is associated with a third cost related to the third optimization strategy; and
determining the plurality of values based on the third set of values.

6. The method of claim 5, further comprising:
storing persistence data comprising first identifying information corresponding to the one or more of: 1) the one or more values of the first set of values, or 2) the first cost, after determining the first set of values; and
after determining the second set of values:
adding, to the persistence data, second identifying information corresponding to the one or more of: 1) the one or more values of the second set of values, or 2) the second cost; and
removing, from the persistence data, the first identifying information;
wherein:
determining the third set of values comprises:
identifying the one or more of: 1) the one or more values of the second set of values, or 2) the second cost, based on the persistence data.

7. The method of claim 2, wherein determining the first set of values comprises solving a first optimization problem corresponding to the first optimization strategy, the first optimization problem comprising minimizing or maximizing one or more first objective functions.

8. The method of claim 7, wherein at least one of the one or more first objective functions is a convex function.

9. The method of claim 7, wherein at least one of the one or more first objective functions is a non-convex function.

10. The method of claim 1, wherein:
the plurality of energy assets comprise at least one electric vehicle supply equipment (EVSE); and
the plurality of operational parameters comprise a charging rate for the at least one EVSE.

11. The method of claim 1, wherein:
the plurality of energy assets comprise at least one energy storage device; and
the plurality of operational parameters comprise a charge or discharge amount for the at least one energy storage device.

12. The method of claim 1, wherein the plurality of energy assets comprise one or more of: one or more electric vehicle supply equipments (EVSEs), one or more battery energy storage systems, one or more heat batteries, one or more solar photovoltaic (PV) systems, one or more generators, one or more fuel cells, one or more Heating, Ventilation, and Air Conditioning (HVAC) systems, one or more lighting controls, or one or more water heaters.

13. The method of claim 1, further comprising providing a user interface for receiving one or more user inputs corresponding to the input.

14. A processing system, comprising: one or more memories; and one or more processors, coupled to the one or more memories, configured to cause the processing system to:
receive an input indicative of selection of a first optimization strategy and a second optimization strategy of a plurality of optimization strategies related to controlling a plurality of energy assets;
determine a plurality of values for a plurality of operational parameters for the plurality of energy assets based on the first optimization strategy and the second optimization strategy, wherein to cause the processing system to determine the plurality of values for the plurality of operational parameters for the plurality of energy assets, the one or more processors are configured to cause the processing system to determine a first value for a first operational parameter for a first energy asset based on the first optimization strategy and the second optimization strategy; and
control the plurality of energy assets based on the plurality of operational parameters.

15. The processing system of claim 14, wherein to cause the processing system to determine the plurality of values, the one or more processors are further configured to cause the processing system to:
determine a first set of values for the plurality of operational parameters based on the first optimization strategy, wherein the first set of values is associated with a first cost related to the first optimization strategy;
determine a second set of values for the plurality of operational parameters based on:
the second optimization strategy; and
one or more of: 1) one or more values of the first set of values, or 2) the first cost,
wherein the second set of values is associated with a second cost related to the second optimization strategy; and
determine the plurality of values based on the second set of values.

16. The processing system of claim 15, wherein:
the input is further indicative of selection of a third optimization strategy of the plurality of optimization strategies; and
to cause the processing system to determine the plurality of values, the one or more processors are further configured to cause the processing system to:
determine a third set of values for the plurality of operational parameters based on:
the third optimization strategy;
the one or more of: 1) the one or more values of the first set of values, or 2) the first cost; and
one or more of: 1) one or more values of the second set of values, or 2) the second cost,
wherein the third set of values is associated with a third cost related to the third optimization strategy; and
determine the plurality of values based on the third set of values.

17. The processing system of claim 16, wherein the one or more processors are further configured to cause the processing system to:
store persistence data comprising first identifying information corresponding to the one or more of: 1) the one or more values of the first set of values, or 2) the first cost; and
add, to the persistence data, second identifying information corresponding to the one or more of: 1) the one or more values of the second set of values, or 2) the second cost;
wherein:
to cause the processing system to determine the third set of values, the one or more processors are configured to cause the processing system to:
identify the one or more of: 1) the one or more values of the first set of values, or 2) the first cost, based on the persistence data; and
identify the one or more of: 1) the one or more values of the second set of values, or 2) the second cost, based on the persistence data.

18. The processing system of claim 15, wherein:
the input is further indicative of selection of a third optimization strategy of the plurality of optimization strategies; and
to cause the processing system to determine the plurality of values, the one or more processors are further configured to cause the processing system to:
determine a third set of values for the plurality of operational parameters based on:
the third optimization strategy; and
one or more of: 1) one or more values of the second set of values, or 2) the second cost,
wherein the third set of values is associated with a third cost related to the third optimization strategy; and
determine the plurality of values based on the third set of values.

19. The processing system of claim 18, wherein the one or more processors are further configured to cause the processing system to:
store persistence data comprising first identifying information corresponding to the one or more of: 1) the one or more values of the first set of values, or 2) the first cost, after determining the first set of values; and
after determining the second set of values:
add, to the persistence data, second identifying information corresponding to the one or more of: 1) the one or more values of the second set of values, or 2) the second cost; and
remove, from the persistence data, the first identifying information;
wherein:
to cause the processing system to determine the third set of values, the one or more processors are configured to cause the processing system to:
identify the one or more of: 1) the one or more values of the second set of values, or 2) the second cost, based on the persistence data.

20. The processing system of claim 15, wherein to cause the processing system to determine the first set of values, the one or more processors are configured to cause the processing system to solve a first optimization problem corresponding to the first optimization strategy, the first optimization problem comprising minimizing or maximizing one or more first objective functions.
